(19) United States
(12) Patent Application Publication
(10) Pub. No.: US 2009/0219958 A1
(43) Pub. Date: Sep. 3, 2009

(54) WAVELENGTH CONVERTING LASER AND IMAGE DISPLAY

(76) Inventors: Tetsuro MIZUSHIMA, Hyogo (JP); Hiroyuki FURUYA, Osaka (JP); Shinichi SHIKII, Nara (JP); Koichi KUSUKAME, Osaka (JP); Nobuyuki HORIKAWA, Osaka (JP); Kiminori MIZUUCHI, Ehime (JP); Kazuhisa YAMAMOTO, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/358,912

(22) Filed: Jan. 23, 2009

Related U.S. Application Data
(60) Provisional application No. 61/022,947, filed on Jan. 23, 2008.

(51) Int. Cl. H01S 3/10; G02F 1/35

(52) U.S. Cl. 372/22; 359/328

(57) ABSTRACT

A wavelength converting laser includes: a fundamental-wave laser light source emitting a fundamental wave; and a wavelength conversion element converting the fundamental wave emitted from the fundamental-wave laser light source into a converted wave having a different wavelength from the fundamental wave, in which: a pair of fundamental-wave reflecting surfaces is arranged on both end sides of the wavelength conversion element in the directions of an optical axis thereof and reflects the fundamental wave to thereby pass the fundamental wave a plurality of times inside of the wavelength conversion element, and at least one of the fundamental-wave reflecting surfaces transmits the converted wave; and the pair of fundamental-wave reflecting surfaces allows the fundamental wave to cross inside of the wavelength conversion element and form a plurality of light-concentration points at places different from a cross point of the fundamental wave. The wavelength converting laser is capable of obtaining a high conversion efficiency stably and being miniaturized.

This application is entitled to the benefit of Provisional Patent Application No. 61/022,947, filed in United States Patent and Trademark Office on Jan. 23, 2008.

### BACKGROUND OF THE INVENTION

1. Field of the Invention

The present invention relates to a wavelength converting laser capable of converting the wavelength of a fundamental wave and outputting a converted wave having a different wavelength from the fundamental wave, and an image display including the wavelength converting laser.

2. Description of the Background Art

Conventionally, there is a wavelength converting laser converting the wavelength of a fundamental wave into a converted wave such as a second harmonic, a sum frequency and a difference frequency by utilizing the non-linear optical phenomenon of a wavelength conversion element.

FIG. 17 is a schematic view showing a configuration of a conventional wavelength converting laser including, for example, a fundamental-wave laser light source 301, a lens 302 concentrating a fundamental-wave laser beam emitted from the fundamental-wave laser light source 301, a wavelength conversion element 303 generating a second harmonic from the concentrated fundamental-wave laser beam, and a dichroic mirror 304 splitting the fundamental-wave laser beam and the harmonic laser beam.

The wavelength conversion element 303 is made of a non-linear optical crystal and converts the wavelength of a fundamental wave by properly adjusting the crystal orientation, polarization inversion structure or the like in such a way that the phase of the fundamental wave matches with the phases of a converted wave. Particularly, a wavelength conversion element using the polarization inversion structure can conduct a wavelength conversion efficiently even with low power by quasi phase matching and conduct diverse wavelength conversions by design. The polarization inversion structure is a structure having a region in which the spontaneous polarization of a non-linear optical crystal is cyclically inverted.

A conversion efficiency η at which a fundamental wave is converted into a second harmonic is given by the following expression (1) if the interaction length of a wavelength conversion element is L, the power of a fundamental wave is P, the cross-section area of a beam in the wavelength conversion element is A and the gap from a phase matching condition is Δk.

η∝L²P/A×sinc²(ΔkL/2) (1)

If a light-concentration condition is set to be suitable for the interaction length, the conversion efficiency η is given by the following expression (2).

η∝LP×sinc²(ΔkL/2) (2)

It can be seen from the expression (2) that the conversion efficiency rises by extending the interaction length or increasing the fundamental-wave power. However, since the allowable range for the gap from a phase matching condition is inversely proportional to the interaction length, the conditions for temperature regulation and the fundamental wave become stricter as the interaction length becomes greater. Further, a rise in the fundamental-wave power may destroy the end faces of the wavelength conversion element or lower the conversion efficiency because of heat generated through optical absorption.

For example, Japanese Patent Laid-Open Publication No. 2004-125943 proposes a wavelength converter capable of conducting a wavelength conversion efficiently without any optical damage by including a light guiding means for guiding an incident laser beam to a plurality of optical paths on a mutually-different straight line, a wavelength converting means arranged on the plurality of optical paths, and a laser-beam extracting means for extracting the laser beam whose wavelength is converted by the wavelength converting means.

Furthermore, for example, Japanese Patent Laid-Open Publication No. 11-44897 proposes a wavelength converting laser capable of conducting a wavelength conversion efficiently by including a plurality of wavelength conversion elements arranged in sequence on an incident fundamental-wave laser-beam path, a plurality of light concentrating means for converging a laser beam passing through the plurality of wavelength conversion elements, and a beam splitter changing the path of the laser beam whose wavelength is converted by the plurality of wavelength conversion elements.

Moreover, for example, Japanese Patent Laid-Open Publication No. 2006-208629 proposes a wavelength conversion element having a higher wavelength-conversion efficiency by: reflecting a beam of light which is incident upon the incidence end of a polarization inversion element, is subjected to a wavelength conversion and reaches the other end thereof by a reflector arranged at the other end of the polarization inversion element to thereby change the optical path and lead the beam to be incident again upon the polarization inversion element and leading the beam again into passing into the polarization inversion element to thereby convert the wavelength thereof.

Although the above conventional proposals are capable of obtaining a high conversion efficiency even if a wavelength conversion element has a short interaction length, a plurality of beams are outputted, thereby requiring a plurality of optical parts for coordinating those beams. Further, the conventional proposals enlarge the effective light-source area of a converted wave, thereby making it hard to concentrate the converted wave. Still further, those proposals raise the problem of increasing the cost because a larger area is necessary for a wavelength conversion element. In addition, a wavelength converting laser needs a plurality of optical parts, thereby requiring looser regulations on the parts to bring the product onto the market.

### SUMMARY OF THE INVENTION

In order to solve the above problems, it is an object of the present invention to provide a wavelength converting laser and an image display which are capable of obtaining a high conversion efficiency stably and being miniaturized.

A wavelength converting laser according to an aspect of the present invention includes: a light source emitting a fundamental wave; and a wavelength conversion element converting the fundamental wave emitted from the light source into a converted wave having a different wavelength from the fundamental wave, in which: a pair of fundamental-wave reflecting surfaces is arranged on both end sides of the wavelength conversion element in the directions of an optical axis thereof and reflects the fundamental wave to thereby pass the fundamental wave a plurality of times inside of the wavelength conversion element, and at least one of the fundamental-wave reflecting surfaces transmits the converted wave; and the pair of fundamental-wave reflecting surfaces allows the fundamental wave to cross inside of the wavelength conversion element and form a plurality of light-concentration points at places different from a cross point of the fundamental wave.

According to this configuration, the pair of fundamental-wave reflecting surfaces allows the fundamental wave to pass a plurality of times inside of the wavelength conversion element, cross inside of the wavelength conversion element and form a plurality of light-concentration points at places different from a cross point of the fundamental wave.

According to the present invention, the fundamental wave passes a plurality of times inside of the wavelength conversion element and forms a plurality of light-concentration points at places different from a cross point of the fundamental wave, thereby making it possible to obtain a high conversion efficiency stably and reduce the light-source area of a converted wave emitted as a plurality of beams, resulting in the whole apparatus being smaller.

### BRIEF DESCRIPTION OF THE DRAWINGS

FIG. 1 is a schematic view showing an exterior shape of a wavelength conversion element according to a first embodiment of the present invention.

FIG. 2A is a schematic top view showing a configuration of a wavelength converting laser according to the first embodiment.

FIG. 2B is a schematic side view showing a configuration of the wavelength converting laser according to the first embodiment.

FIG. 3 is a perspective view showing a configuration of a temperature regulator according to the first embodiment.

FIG. 4 is a schematic view showing an exterior shape of a wavelength conversion element according to a second embodiment of the present invention.

FIG. 5A is a schematic top view showing a configuration of a wavelength converting laser according to the second embodiment.

FIG. 5B is a schematic side view showing a configuration of the wavelength converting laser according to the second embodiment.

FIG. 6 is a schematic view showing a configuration of a multi-mode optical fiber connected to the wavelength converting laser of FIGS. 5A and 5B.

FIG. 7 is schematic view showing a configuration of a wavelength converting laser according to a third embodiment of the present invention.

FIG. 8 is schematic top view showing a configuration of a wavelength converting laser according to a fourth embodiment of the present invention.

FIG. 9 is schematic top view showing a configuration of a wavelength converting laser according to a fifth embodiment of the present invention.

FIG. 10A is schematic top view showing a configuration of a wavelength converting laser according to a sixth embodiment of the present invention.

FIG. 10B is schematic side view showing a configuration of the wavelength converting laser according to the sixth embodiment.

FIG. 11A is schematic top view showing a configuration of a wavelength converting laser according to a seventh embodiment of the present invention.

FIG. 11B is schematic side view showing a configuration of the wavelength converting laser according to the seventh embodiment.

FIG. 12A is schematic top view showing a configuration of a wavelength converting laser according to an eighth embodiment of the present invention.

FIG. 12B is schematic side view showing a configuration of the wavelength converting laser according to the eighth embodiment.

FIG. 13 is schematic view showing a configuration of an image display including the wavelength converting laser of FIGS. 12A and 12B.

FIG. 14 is schematic view showing a configuration of a wavelength converting laser according to a ninth embodiment of the present invention.

FIG. 15 is a schematic view showing an exterior shape of a wavelength conversion element according to a tenth embodiment of the present invention.

FIG. 16A is schematic top view showing a configuration of a wavelength converting laser according to the tenth embodiment.

FIG. 16B is schematic side view showing a configuration of the wavelength converting laser according to the tenth embodiment.

FIG. 17 is a schematic view showing a configuration of a conventional wavelength converting laser.

### DETAILED DESCRIPTION OF THE PREFERRED EMBODIMENTS OF THE INVENTION

Embodiments of the present invention will be below described with reference to the attached drawings. The following embodiments, however, are merely specific examples, and thus, the scope of an art of the present invention is not supposed to be limited.

### First Embodiment

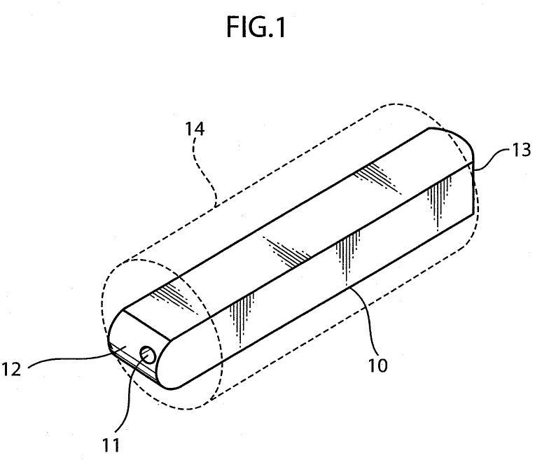

FIG. 1 is a schematic view showing an exterior shape of a wavelength conversion element 10 according to a first embodiment of the present invention. The wavelength conversion element 10 is made of an MgO:LiNbO₃ crystal having a polarization inversion period structure and is shaped like a rod having a length of, for example, 10 mm and a width and a thickness of, for example, 1 mm, respectively. The wavelength conversion element 10 converts a fundamental wave into a converted wave having a different wavelength from the fundamental wave. One end face 12 of the wavelength conversion element 10 in the longitudinal directions is formed with a fundamental-wave inlet 11 for incidence of the fundamental wave. Both end faces of the rod-shaped wavelength conversion element 10 in the longitudinal directions are formed, except for the fundamental-wave inlet 11, with a fundamental-wave reflective coat for reflecting the fundamental wave.

The other end face 13 in the longitudinal directions without the fundamental-wave inlet 11 is formed with the fundamental-wave reflective coat for reflecting the fundamental wave and a converted-wave transmission coat for transmitting the converted wave as a face for outputting the converted wave. The end face 12 is formed with a converted-wave reflective coat for reflecting the converted wave. Hence, the wavelength conversion element 10 includes the output face of the converted wave only in the other end face 13 in the longitudinal directions.

The fundamental-wave inlet 11 is shifted toward the lateral end from the center of the end face 12, has a diameter of, for example, 100 μm and is formed with an AR (anti-reflective) coat for the fundamental wave. The end face 12 with the fundamental-wave inlet 11 has a convex cylindrical shape bent in the vertical directions of FIG. 1 while the other end face 13 has a convex cylindrical shape bent in the lateral directions of FIG. 1. The curvature radii of both end faces 12 and 13 are each, for example, 13 mm.

The side faces of the wavelength conversion element 10 are coated with a resin clad 14 having a refractive index lower than the wavelength conversion element 10, and via the resin clad 14, the wavelength conversion element 10 is fixed on a holder and undergoes temperature regulation. The resin clad 14 coats the face other than the end faces 12 and 13 of the wavelength conversion element 10.

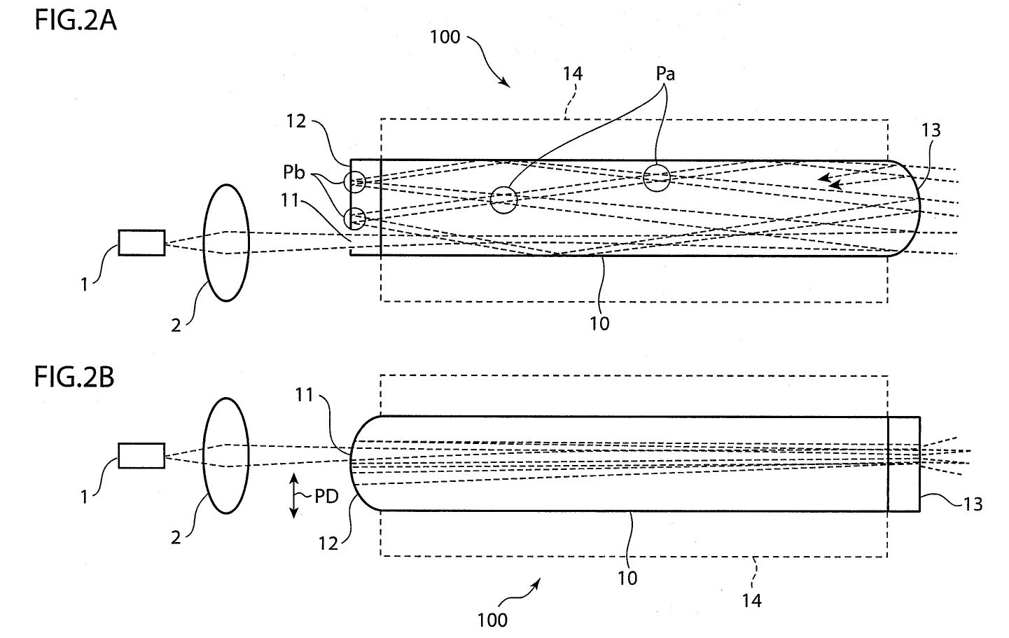

FIG. 2A is a schematic top view showing a configuration of a wavelength converting laser according to the first embodiment and FIG. 2B is a schematic side view showing a configuration of the wavelength converting laser according to the first embodiment. FIGS. 2A and 2B show the optical paths of a fundamental wave and a converted wave and are top and side views of the rod-shaped wavelength conversion element 10, respectively.

A wavelength converting laser 100 includes a fundamental-wave laser light source 1, a condensing lens 2, the wavelength conversion element 10 and the resin clad 14.

A fundamental wave emitted from the fundamental-wave laser light source 1 is concentrated into the fundamental-wave inlet 11 by the condensing lens 2 and incident upon the wavelength conversion element 10, goes ahead in the longitudinal direction of the wavelength conversion element 10 and undergoes a wavelength conversion, and is reflected by the end face 13 and advances again inside of the wavelength conversion element 10. Through the process, a converted wave is obtained and emitted from the end face 13. The fundamental-wave inlet 11 is shifted from the rod center axis and the end face 13 has a curvature in the direction where the fundamental-wave inlet 11 is shifted from the rod center axis, thereby causing the fundamental wave to slant and reflect laterally in top view lest it should return to the fundamental-wave inlet 11.

The end face 13 and the end face 12 are formed with the reflective coats and the side faces of the wavelength conversion element 10 are coated with the resin clad 14. Accordingly, the fundamental wave is reflected by the end face 13 and the end face 12 and is totally reflected by the side-face resin clad 14, and thereby, goes back and forth repeatedly in the longitudinal directions inside of the wavelength conversion element 10. The end face 12 and the end face 13 function as a concave (cylindrical) mirror for enabling the fundamental wave to form a light-concentration point when going back and forth.

The fundamental wave going back and forth inside of the wavelength conversion element 10 crosses inside of the wavelength conversion element 10 and forms a light-concentration point Pb produced by the curvatures of the end face 12 and the end face 13 other than the light-concentration point formed by the condensing lens 2.

At this time, a plurality of the light-concentration points Pb are formed at places different from a cross point Pa of the fundamental wave. In the first embodiment, the end face 12 and the end face 13 include cylindrical surfaces, thereby forming the light-concentration points Pb differing each other in the beam-diameter directions.

The converted wave is reflected by the end face 12 and the side faces of the wavelength conversion element 10, led to the end face 13 and emitted as the flux of a plurality of beams from the end face 13. The end face 13 has a rectangular shape whose sides are, for example, 1 mm and thus is an extremely small outlet, and the cylindrical shape thereof functions as a convex lens for the converted wave, thereby narrowing the divergence angle of a luminous flux spreading laterally in top view and emitting the luminous flux.

In the first embodiment, the end faces 12 and 13 of the wavelength conversion element 10 correspond to an example of the pair of fundamental-wave reflecting surfaces and the resin clad 14 corresponds to an example of the reflection portion.

In the first embodiment, the wavelength conversion element 10 includes the fundamental-wave reflecting surface on both sides in the longitudinal directions thereof, at least one fundamental-wave reflecting surface transmits the converted wave, the fundamental wave crosses inside of the wavelength conversion element 10, and a light-concentration point is formed at a place different from a cross point. This makes it possible to enhance the conversion efficiency, simultaneously collect the converted wave emitted as a plurality of beams into one place to thereby reduce the light-source area thereof, and reduce the area necessary for the wavelength conversion element 10. The fundamental wave going back and forth between the pair of fundamental-wave reflecting surfaces makes a plurality of passes inside of the wavelength conversion element 10, and the fundamental wave going back and forth forms a plurality of light-concentration points, thereby making the conversion efficiency several times as high as the case where the fundamental wave passes only once inside of a wavelength conversion element.

On the other hand, if the fundamental wave does not converge while passing several times inside of the wavelength conversion element 10, the effect of diffraction widens the beam diameter of the fundamental wave to lower the power density, thereby raising the conversion efficiency only a little. In the first embodiment, however, the beams passing inside of the wavelength conversion element 10 have the light-concentration points, thereby raising the conversion efficiency significantly without lowering the power density of the fundamental wave. Besides, when the fundamental wave goes back and forth between the fundamental-wave reflecting surfaces, the converted wave is outputted from at least one fundamental-wave reflecting surface, thereby reducing the interaction length for wavelength conversion to or below the length of one round trip of the wavelength conversion element 10. This is useful for avoiding the problem of extending the interaction length.

In the first embodiment, the fundamental wave going back and forth in the longitudinal directions crosses inside of the wavelength conversion element 10, thereby reducing the area in the width and thickness directions of the wavelength conversion element 10 which the fundamental wave passes through.

A part of the wavelength conversion element 10 through which the fundamental wave passes becomes a source generating the converted wave, and thus, the cross-section area in the width and thickness directions of the wavelength conversion element 10 is reduced, thereby reducing the light-source area. The cross-section area which the converted wave passes through is also made smaller, thereby enabling a simple optical part to control a plurality of beams.

In the first embodiment, there are the cross points and the light-concentration points of the fundamental wave inside of the wavelength conversion element 10. At this time, if the cross points and the light-concentration points of the fundamental wave are concentrated, the power density of the fundamental wave becomes too high, thereby giving damage or optical absorption to the wavelength conversion element 10 to stagnate the wavelength conversion at the cross points and the light-concentration points. In the first embodiment, however, since there are the plurality of light-concentration points at places different from the cross points of the fundamental wave, the places where the power density is high and the wavelength conversion is intensely conducted can be dispersed, thereby obtaining a high conversion efficiency stably. In the first embodiment, the cross point of the fundamental wave indicates a point at which the fundamental-wave optical paths overlap in space except for an intersection formed by reflection.

In the first embodiment, a part of the fundamental wave incident upon the wavelength conversion element 10 is emitted from the fundamental-wave inlet 11, and in order to prevent the fundamental wave from returning to the fundamental-wave laser light source 1, preferably, an optical isolator or the like for may be employed. Alternatively, it may be appreciated that a shielding cover absorbing the fundamental wave emitted from the wavelength conversion element 10 is employed around the fundamental-wave inlet 11.

In the first embodiment, it is preferable that the fundamental wave is reflected by not only the pair of fundamental-wave reflecting surfaces in the longitudinal directions of the wavelength conversion element 10 but also the side faces of the wavelength conversion element 10 to thereby return the fundamental wave into the wavelength conversion element 10. Ordinarily, the area in the width and thickness directions of the wavelength conversion element 10 which the fundamental wave passes through becomes larger as the fundamental wave goes back and forth more times, and the fundamental wave equivalent to this increment in the area cannot be acquired.

In the first embodiment, however, the side faces of the wavelength conversion element 10 is formed with the resin clad (reflection portion) 14 reflecting the fundamental wave into the wavelength conversion element 10, thereby keeping the area within a specified range which the fundamental wave passes through inside of the wavelength conversion element 10. Besides, the side faces of the wavelength conversion element 10 reflect the fundamental wave, thereby limiting the fundamental-wave passage area and setting the converted-wave light-source area, so that the emitted converted wave can be easily controlled. In addition, the side faces of the wavelength conversion element 10 reflect the fundamental wave, thereby unifying the intensity distribution of the fundamental wave passing through the wavelength conversion element 10 to disperse the places having higher fundamental-wave power densities. It is preferable that the side faces of the wavelength conversion element 10 reflect the fundamental wave as well as the converted wave, thereby leading the converted wave to the end face 13 on the output side having a specified area and making the converted-wave intensity uniform.

In the first embodiment, it is preferable that the side faces of the wavelength conversion element 10 is coated with a material having a refractive index lower than the wavelength conversion element 10. The side faces of the wavelength conversion element 10 coated with this material reflects the fundamental wave and the converted wave totally to thereby return the fundamental wave and the converted wave into the wavelength conversion element 10. Besides, a coating portion (reflection portion) can be employed as a protective layer and a heat-insulating layer for the wavelength conversion element 10. Particularly, the coating portion may preferably be a deformable and workable resin material. A non-linear crystal forming the wavelength conversion element 10 is hard and brittle and can be broken by an impact, but becomes stronger against a vibration or a deformation when coated with the resin material. Further, working the resin material makes it easier to join it to a holding portion holding the wavelength conversion element 10. The resin material includes, for example, a UV-curing resin, a thermoset resin, a thermoplastic resin and the like.

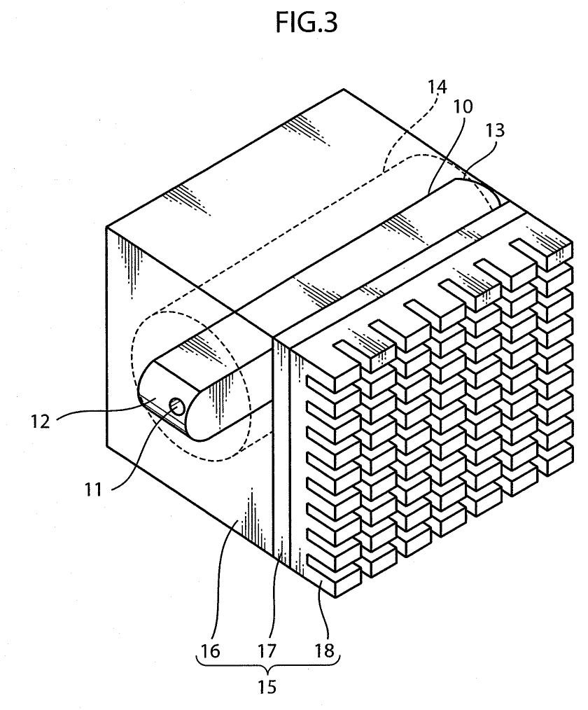

The resin clad 14 is joined to a temperature regulator constantly regulating the temperature of the wavelength conversion element 10. FIG. 3 is a perspective view showing a configuration of a temperature regulator according to the first embodiment. A temperature regulator 15 includes a metal holder 16, a Peltier element 17 and a radiation fin 18.

The metal holder 16 is made of a rectangular, metal material and holds the wavelength conversion element 10 and the resin clad 14 so as to cover the side surface of the resin clad 14 over the full circumference. The cooling surface of the Peltier element 17 is joined to a side face of the metal holder 16 and absorbs heat from the metal holder 16.

The radiation fin 18 is arranged on the side of the heat-radiating surface of the Peltier element 17 and radiates heat from the Peltier element 17. The heat generated from the wavelength conversion element 10 is transferred to the resin clad 14 and the metal holder 16, and the metal holder 16 is cooled by the Peltier element 17. Then, the radiation fin 18 radiates the heat emitted from the Peltier element 17.

In the first embodiment, it is preferable that the temperature regulator 15 is connected to the reflection portion (resin clad 14) coating the wavelength conversion element 10. If the temperature regulator 15 is connected directly to the wavelength conversion element 10, the connection part of the wavelength conversion element 10 and the temperature regulator 15 can absorb the fundamental wave going back and forth between the reflecting surfaces, thereby hindering precisely executing the function of regulating the temperature.

In the first embodiment, however, the reflection portion (resin clad 14) totally reflecting the fundamental wave and the converted wave is connected to the temperature regulator 15, thereby preventing the fundamental wave and the converted wave from being absorbed into the temperature regulator 15, so that precise temperature control can be executed. Besides, the reflection portion (resin clad 14) covers the side faces of the wavelength conversion element 10 over the full periphery, thereby also keeping the whole wavelength conversion element 10 at a fixed temperature.

The fundamental-wave laser light source 1 is formed by a fiber laser generating an oscillation having a wavelength of 1064 nm and having a linear polarization. In the wavelength converting laser 100, polarization directions PD of the fundamental wave incident upon the wavelength conversion element 10 are the up-and-down directions in the side view of FIG. 2B. The polarization directions PD of the fundamental wave corresponds to the z-axis directions of an MgO:LiNbO₃ crystal having a polarization inversion structure, thereby enabling an efficient wavelength conversion.

The sectional shape of a plane perpendicular to the optical axis of the wavelength conversion element 10 is a rectangle having sides parallel to the polarization directions PD and sides perpendicular thereto. In the first embodiment, it is preferable that the sectional shape of a plane perpendicular to the optical axis of the wavelength conversion element 10 is rectangular, at least one side is parallel to the polarization directions PD of the fundamental wave incident upon the wavelength conversion element 10 and the side faces of the wavelength conversion element 10 reflect the fundamental wave.

In the first embodiment, the fundamental wave is returned into the wavelength conversion element 10 using the reflection by the side faces of the wavelength conversion element 10. If the polarization directions change at this time, the conversion efficiency lowers. In the first embodiment, however, the reflecting side faces are parallel or perpendicular to the polarization directions, thereby removing a change in the polarization directions to enable an efficient wavelength conversion even using the side-face reflection. Since the non-linear optical crystal has an optical axis, the polarization directions need to coincide with the optical axis for conducting a wavelength conversion.

In the first embodiment, it is preferable that the end faces of the wavelength conversion element 10 are the fundamental-wave reflecting surfaces and each have a convex shape. Furthermore, in the first embodiment, it is preferable that the pair of fundamental-wave reflecting surfaces is formed in both end faces of the wavelength conversion element 10, respectively, in the optical-axis directions thereof, and at least one of both end faces of the wavelength conversion element 10 has a convex shape.

The wavelength conversion element 10 includes the fundamental-wave reflecting surfaces in both end faces in the longitudinal directions, and each end face is shaped like a convex cylinder whose axis is perpendicular to each other. The end faces of the wavelength conversion element 10 also serve as the fundamental-wave reflecting surfaces, thereby saving the process of coordinating the wavelength conversion element 10 and the fundamental-wave reflecting surfaces. Conventionally, if the fundamental wave passes several times inside of the non-linear optical crystal, there may occur a drawback that the number of coordination axes increases, the first embodiment realizes a compact configuration capable of decreasing the number of coordination axes and passing the fundamental wave to be concentrated a plurality of times inside of the wavelength conversion element 10.

In addition, the fundamental wave goes back and forth inside of the wavelength conversion element 10, and thus, there is no face transmitting the fundamental wave when passing through the wavelength conversion element 10, thereby eliminating an optical loss. The convex end face of the wavelength conversion element 10 works as a concave mirror for the fundamental wave to be reflected to thereby form a light-concentration point inside of the wavelength conversion element 10. On the other hand, the convex end face of the wavelength conversion element 10 reflecting the fundamental wave and transmitting the converted wave works as a convex lens for the converted wave to thereby narrow the divergence angle of the converted wave to be emitted.

Alternatively, it may be appreciated that only one of both end faces of the wavelength conversion element 10 is formed with a convex fundamental-wave reflecting surface, or the convex shape is not spherical but non-spherical.

In the first embodiment, preferably, at least one of both end faces of the wavelength conversion element 10 having the fundamental-wave reflecting surfaces may have a convex cylindrical shape. The fundamental-wave reflecting surface is a cylindrical surface to cause light-concentration points formed inside of the wavelength conversion element 10 to differ in the beam-diameter directions, thereby preventing the power density of the fundamental wave from concentrating.

Besides, the convex surface is cylindrical to decrease the number of coordination axes by one, compared with it is spherical, thereby facilitating the coordination process.

Further, the end faces of the wavelength conversion element 10 are also worked for a single axis, thereby enabling a reduction in the manufacturing cost.

Particularly, it is preferable that in the wavelength conversion element 10 having a rectangular shape in section, the axial directions of a cylindrical surface coincide with the sides of the rectangular cross section. This make it possible to prevent the fundamental wave from turning in the polarization direction when reflecting the side faces of the wavelength conversion element 10.

It is preferable that both end faces of the wavelength conversion element 10 are convex-cylindrical fundamental-wave reflecting surfaces, and the axes of the cylindrical shapes are perpendicular to each other. The axes of the two reflecting surfaces capable of concentrating light cross at right angles, thereby causing light-concentration points formed inside of the wavelength conversion element 10 to differ in the directions perpendicular to each other. Besides, the axes of the cylindrical shapes are perpendicular to each other, and thereby, the two coordination axes of the wavelength conversion element 10 can be handled independent of each other, thereby facilitating the coordination. Further, it is separately worked for each axis, thereby enabling a reduction in the manufacturing cost including the easiness of coordination.

Particularly, it is preferable that the curvature radii of both cylindrical surfaces are equal to or more than the length of the wavelength conversion element 10. The curvature radii are set to the above condition, thereby enabling a beam to go back and forth while securing the concentration characteristics thereof. Particularly, as shown in the side view of the wavelength converting laser 100 of FIG. 2B, the optical path in the diametrical directions having a narrow positional gap between the optical axis and the fundamental-wave inlet 11 becomes a stable resonance condition, thereby bringing the beam diameter within a specified range even though the beam goes back and forth more times.

Preferably, the wavelength conversion element may have a thickness and a width of 1 mm or below. The thickness and width of the wavelength conversion element 10 is equivalent to the light-source area of the converted wave, and thus, the light-source area is within a range of 1 mm×1 mm, thereby collecting the converted wave within a range narrow enough.

In the first embodiment, a plurality of converted beams are outputted, and those converted beams are collected within a narrower range, thereby allowing each optical part to control beam shaping and propagation or the like, taking no account of the fact that there are several such converted beams.

The fundamental-wave laser light source 1 is a fiber laser, or another type of laser light source such as a semiconductor laser and a solid laser. The condensing lens 2 is used for leading a fundamental-wave laser beam to be incident through the fundamental-wave inlet 11 upon the fundamental-wave reflecting surfaces. In the first embodiment, various optical parts can be employed for leading the fundamental-wave laser beam to be incident upon the pair of fundamental-wave reflecting surfaces. The wavelength conversion element 10 is made of each kind of non-linear material—LBO, KTP, or LiNbO₃ or LiTaO₃ having a polarization inversion period structure.

In the first embodiment, as the fundamental-wave reflecting surfaces, curved surfaces capable of concentrating light are employed in such a way that the fundamental wave crosses inside of the wavelength conversion element 10 to thereby form a plurality of light-concentration points at places different from a cross point. In addition, the light-concentration points according to the first embodiment can be formed simply by concentrating beams incident upon the fundamental-wave reflecting surfaces. In the first embodiment, the fundamental-wave reflecting surfaces are convex cylindrical surfaces, the plurality of light-concentration points are formed at places different from a cross point, and the fundamental wave is crossed through reflection by the side faces of the wavelength conversion element 10 and reflection by the cylindrical surfaces.

The shape of the fundamental-wave inlet 11 is not especially limited, as long as it allows the fundamental wave to be incident between the pair of fundamental-wave reflecting surfaces. In the first embodiment, the end face 12 is circularly masked when the reflective coat thereof is formed, thereby designing only the fundamental-wave inlet 11 as a fundamental-wave transmission surface. Alternatively, it may be appreciated that a part of the fundamental-wave reflecting surface is worked into the fundamental-wave inlet 11. In the first embodiment, the fundamental-wave inlet 11 is largely shifted laterally and slightly shifted longitudinally from the center of the end face 12 of the wavelength conversion element 10. However, the position is the fundamental-wave inlet 11 is not especially limited.

Furthermore, in the first embodiment, the face for outputting the converted wave is only one end face of the wavelength conversion element 10. However, the end face 12 may be covered with a transmission coat for the converted wave in such a way that the converted wave is outputted from both end faces.

Moreover, it is preferable that a light-concentration point formed for the first time by the fundamental wave inside of the wavelength conversion element 10 has an elliptic beam shape. In the first embodiment, first, the lens power of the condensing lens 2 concentrates the fundamental wave inside of the wavelength conversion element 10. At this time, the condensing lens 2 causes the fundamental wave to have a effectively different NA (numerical aperture) in the two axial directions and be incident as an elliptic beam upon the wavelength conversion element 10. Especially, the first light-concentration point tends to have a higher power density because the conversion has not yet progressed and the fundamental-wave power remains great. Accordingly, the beam shape of a light-concentration point formed for the first time by the fundamental wave inside of the wavelength conversion element 10 is set to an ellipse, thereby preventing the first light-concentration point from having a higher power density.

### Second Embodiment

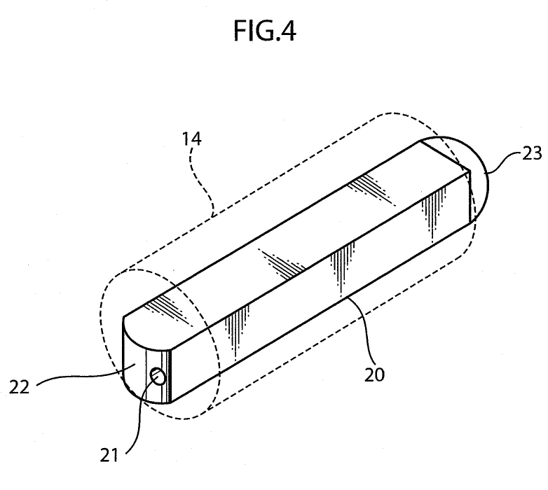

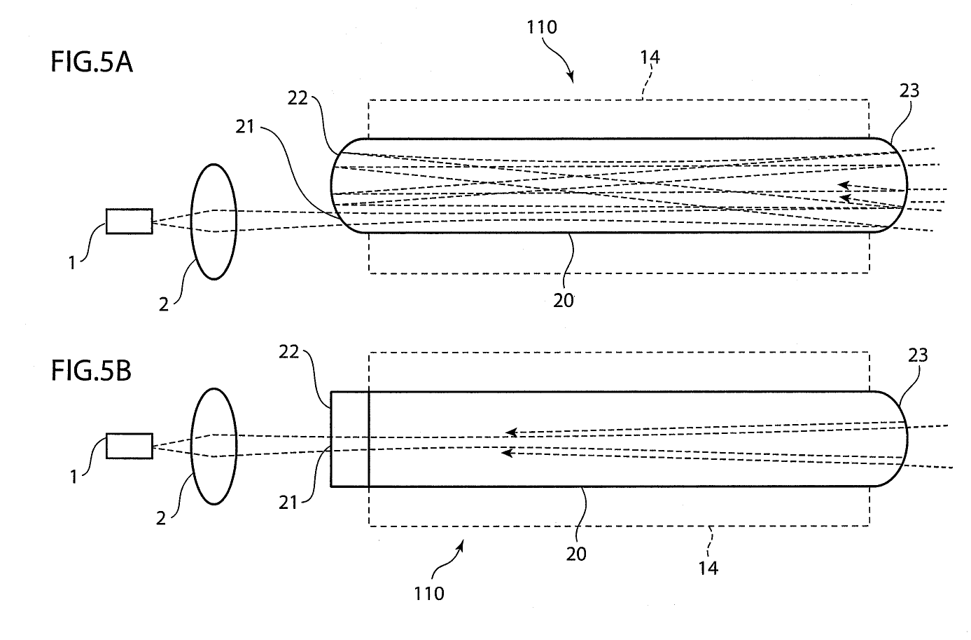

FIG. 4 is a schematic view showing an exterior shape of a wavelength conversion element 20 according to a second embodiment of the present invention. FIG. 5A is a schematic top view showing a configuration of a wavelength converting laser according to the second embodiment and FIG. 5B is a schematic side view showing a configuration of the wavelength converting laser according to the second embodiment. In the second embodiment, component elements are given the same reference characters and numerals as those of the first embodiment, as long as the former are identical to the latter, and thus, their description is omitted.

A wavelength converting laser 101 includes a fundamental-wave laser light source 1, a condensing lens 2, a wavelength conversion element 20 and a resin clad 14.

The wavelength conversion element 20 is made of LiTaO₃ crystal having a polarization inversion period structure and is shaped like a rod having a length of, for example, 10 mm and a width and a thickness of, for example, 0.8 mm, respectively. The wavelength conversion element 20 converts a fundamental wave into a converted wave having a different wavelength from the fundamental wave. One end face 22 of the wavelength conversion element 20 in the longitudinal directions is formed with a fundamental-wave inlet 21 for incidence of the fundamental wave. Both end faces of the rod-shaped wavelength conversion element 20 in the longitudinal directions are formed, except for the fundamental-wave inlet 21, with a fundamental-wave reflective coat for reflecting the fundamental wave.

The other end face 23 in the longitudinal directions without the fundamental-wave inlet 21 is formed with a fundamental-wave reflective coat for reflecting the fundamental wave and a converted-wave transmission coat for transmitting the converted wave as a face for outputting the converted wave. The end face 22 is formed with a converted-wave reflective coat for reflecting the converted wave. Hence, the wavelength conversion element 20 includes the output face of the converted wave only in the end face 23 in the longitudinal directions.

The fundamental-wave inlet 21 is shifted toward the lateral end from the center of the end face 22, has a diameter of, for example, 90 μm and is formed with an AR coat for the fundamental wave. The one end face 22 with the fundamental-wave inlet 21 has a convex cylindrical shape bent in the lateral directions of FIG. 4 while the other end face 23 has a convex spherical shape. The curvature radius of the end face 22 is, for example, 8 mm while the curvature radius of the end face 23 is, for example, 12 mm.

In the second embodiment, the end faces 22 and 23 of the wavelength conversion element 20 correspond to an example of the pair of fundamental-wave reflecting surfaces and the resin clad 14 corresponds to an example of the reflection portion.

A fundamental wave emitted from the fundamental-wave laser light source 1 is concentrated into the fundamental-wave inlet 21 by the condensing lens 2 and incident upon the wavelength conversion element 20, goes ahead in the longitudinal direction of the wavelength conversion element 10 and undergoes a wavelength conversion, and is reflected by the end face 23 and advances again inside of the wavelength conversion element 20. Through the process, a converted wave is obtained and emitted from the end face 23. The end face 22 and the end face 23 function as a concave mirror for the fundamental wave, and the fundamental wave goes back and forth while forming a plurality of light-concentration points between the end face 22 and the end face 23. The fundamental wave going back and forth crosses inside of the wavelength conversion element 10 and forms the plurality of light-concentration points at places different from a cross point.

The cylindrical surface forms the light-concentration points different in the beam-diameter directions, and the light-concentration points in the thickness directions of the wavelength conversion element 20 are formed near the end face 22. The condensing lens 2 also forms a light-concentration point at a place different from a cross point. The converted wave is emitted as a plurality of beams from the end face 23 and can be handled as a luminous flux collected within the end face 23. Further, the end face 23 functions as a convex lens for the converted wave and narrows the divergence angle of the converted wave.

In the second embodiment, the wavelength conversion element 20 includes the fundamental-wave reflecting surface on both sides in the longitudinal directions thereof, at least one fundamental-wave reflecting surface transmits the converted wave, the fundamental wave crosses inside of the wavelength conversion element 20, and a light-concentration point is formed at a place different from a cross point. This makes it possible to enhance the conversion efficiency, simultaneously collect the converted wave emitted as a plurality of beams into one place to thereby reduce the light-source area thereof, and reduce the area necessary for the wavelength conversion element 20.

In the second embodiment, it is preferable that the end faces of the wavelength conversion element 20 are the fundamental-wave reflecting surfaces and each have a convex shape. The end faces of the wavelength conversion element 20 have the convex fundamental-wave reflecting surfaces, thereby leading the fundamental wave going back and forth inside of the wavelength conversion element 20 to cross and form a light-concentration point inside of the wavelength conversion element 20. In the second embodiment, the end faces of the wavelength conversion element 20 are the concave mirrors for the fundamental wave, thereby leading the fundamental wave to cross and concentrate.

In the wavelength converting laser 101, preferably, one of the pair of fundamental-wave reflecting surfaces is a cylindrical surface and the other is a spherical surface.

At this time, preferably, the direction of the curvature of the cylindrical surface may coincide with the direction in which the fundamental-wave inlet 21 is formed with respect to the surface center thereof. In the second embodiment, the fundamental-wave inlet 21 is shifted laterally from the center of the end face 22 and thus the end face 22 is a cylindrical surface having a lateral curvature. The two end faces have the lateral curvatures, thereby leading the fundamental wave to pass several times and cross inside of the wavelength conversion element 20.

Furthermore, only one of both end faces of the wavelength conversion element 20 is the cylindrical surface, thereby evading beam diffraction in the direction perpendicular to the direction from the curvature center of the end face 22 toward the position in which the fundamental-wave inlet 21 is formed, and preventing the beam diameter from widening while the fundamental wave goes back and forth between the pair of fundamental-wave reflecting surfaces. Particularly, the curvature radius of the spherical surface is greater than the wavelength-conversion element length, thereby becoming a stable resonance condition in the direction where the cylindrical lens has no lens power to keep the beam diameter constant even though the beam goes back and forth more times, so that the conversion efficiency becomes higher.

Moreover, one of both end faces of the wavelength conversion element 20 is designed as the cylindrical surface instead of the spherical surface, thereby reducing the number of coordination and working axes to cut down the laser production cost. Particularly, it is preferable that the total curvature radius of the cylindrical surface and the spherical surface is 1.8 to 2.2 times as long as the distance between the fundamental-wave reflecting surfaces. On this condition, the fundamental wave can go back and forth five or more times between the fundamental-wave reflecting surfaces even though not reflected by the side faces of the wavelength conversion element 20. Unless the curvature radii of the cylindrical surface and the spherical surface meet the above condition, the fundamental wave may stop after going back and forth a couple of times between the fundamental-wave reflecting surfaces.

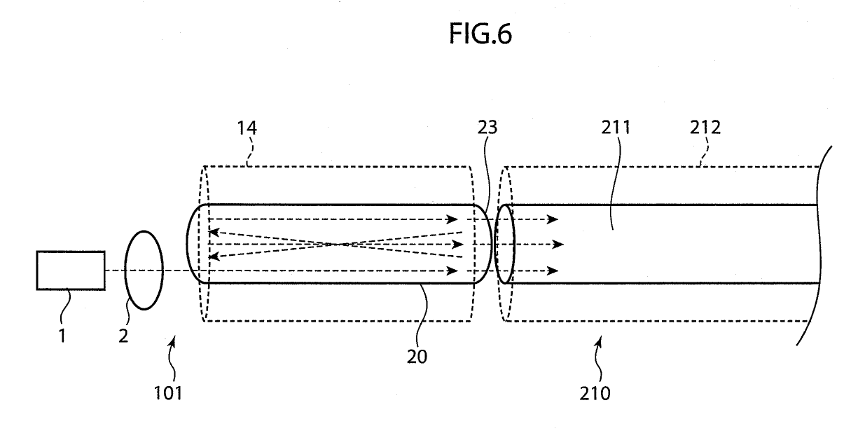

FIG. 6 is a schematic view showing a configuration of a multi-mode optical fiber 210 connected to the wavelength converting laser 101 of FIGS. 5A and 5B. The multi-mode optical fiber 210 includes a core 211 having a diameter of, for example, 0.8 mm and made of pure quartz, and a clad 212 made of F-added quartz, and transmits a beam of light obtained from the wavelength converting laser 101. The core 211 propagates the converted wave from the wavelength converting laser 101 and the clad 212 coats the core 211 and reflects the converted wave into the core 211.

The wavelength conversion element 20 is connected directly to the core 211 and thereby the converted wave emitted from the end face 23 of the wavelength conversion element 20 is transmitted to the core 211. The converted wave emitted from the wavelength conversion element 20 propagates through the core 211 while reflected by the core 211. The connection surface of the core 211 of the multi-mode optical fiber 210 has a coating reflecting the fundamental wave and transmitting the converted wave.

The wavelength conversion element 20 is a rectangle having a thickness and a width of, for example, 0.8 mm, and emits the converted wave made up of a plurality of beams into a small area from the end face 23. The end-face diameter of the wavelength conversion element 20 is substantially equal to the optical-fiber core diameter, thereby enabling the direct connection of the wavelength converting laser 101 and the multi-mode optical fiber 210, though the converted wave is made up of the plurality of beams. The end face 23 has a convex shape to concentrate the converted wave, thereby enhancing the coupling efficiency to the multi-mode optical fiber 210.

In the second embodiment, it is preferable that the end face 23 of the wavelength conversion element 20 is formed with a fundamental-wave reflecting surface reflecting the fundamental wave and transmitting the converted wave and is connected to the multi-mode optical fiber 210. Although the wavelength converting laser 101 of the second embodiment outputs the plurality of converted-wave beams which can be difficult to handle, the plurality of converted-wave beams is emitted as a single luminous flux directly to the multi-mode optical fiber 210, thereby easily transmitting the converted wave to various places. Besides, the wavelength conversion element 20 has a thickness and a width of 1 mm or below, thereby joining the plurality of converted-wave beams directly to the multi-mode optical fiber 210 having a core diameter making the bending easier.

Preferably, the end face 23 of the wavelength conversion element 20 may reflect the fundamental wave, transmit the converted wave and have a convex shape. In the wavelength converting laser 101 of the second embodiment, the thus configured end face 23 of the wavelength conversion element 20 leads the fundamental wave to go back and forth and cross inside of the wavelength conversion element 20 and form a light-concentration point at a plurality of places. In addition, the end face 23 of the wavelength conversion element 20 functions as a lens converging the plurality of outputted converted-wave beams, thereby enhancing the coupling efficiency to an optical part such as an optical fiber. Particularly, in the case where the wavelength converting laser 101 is directly joined to the multi-mode optical fiber 210, since the end face 23 of the wavelength conversion element 20 is shaped like a convex, the coupling efficiency can be heightened even though there is an eccentricity.

In the second embodiment, it is preferable that the multi-mode optical fiber 210 is formed at an end face thereof with a coating reflecting the fundamental wave and transmitting the converted wave from the wavelength converting laser 101.

In the case where the wavelength converting laser 101 is directly joined to the multi-mode optical fiber 210, there can be the problem of separating the converted wave and the fundamental wave leaking from the end face 23 of the wavelength conversion element 20. Taking this into account, the coating on the end face of the core 211 separates the fundamental wave from the wavelength converting laser 101 and the converted wave and thereby transfers only the converted wave. Further, the clad 212 prevents the fundamental wave leaking from the wavelength converting laser 101 from being outputted to the outside.

The core 211 and the clad 212 of the multi-mode optical fiber 210 can be made of quartz, as well as a flexible organic resin material, and the core 211 may be not only circular but also rectangular in section.

### Third Embodiment

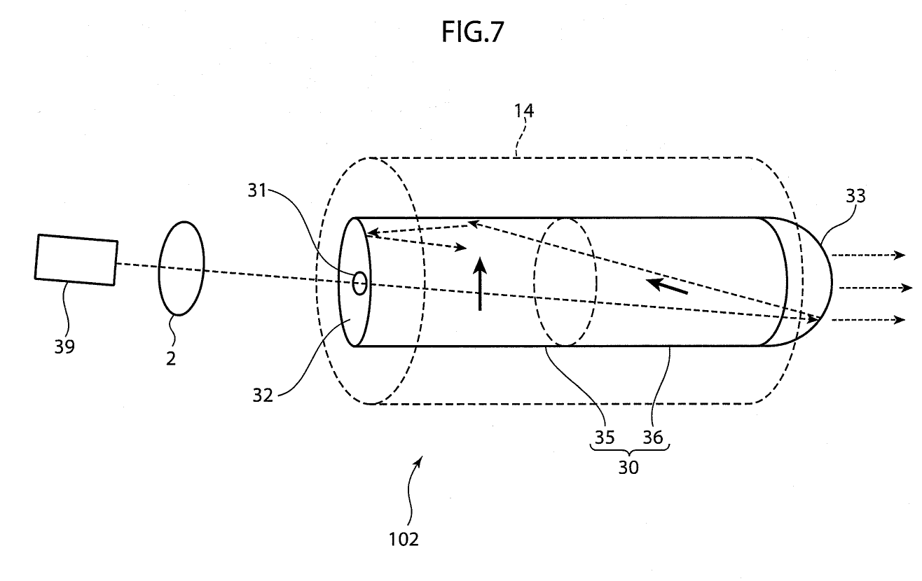

FIG. 7 is schematic view showing a configuration of a wavelength converting laser 102 according to a third embodiment of the present invention. In the third embodiment, component elements are given the same reference characters and numerals as those of the first and second embodiments, as long as the former are identical to the latter, and thus, their description is omitted.

The wavelength converting laser 102 includes a randomly-polarized fundamental-wave laser light source 39, a condensing lens 2, a wavelength conversion element 30 and a resin clad 14.

The wavelength conversion element 30 is made of an MgO:LiNbO₃ crystal (PPMgLN) having a polarization inversion period structure and includes a first wavelength conversion element 35 and a second wavelength conversion element 36 which have a crystal axis perpendicular to each other and are joined together. In FIG. 7, the first wavelength conversion element 35 on the left side is made of PPMgLN↑ having a crystal z-axis in the upward direction of FIG. 7 while the second wavelength conversion element 36 on the right side is made of PPMgLN← having a crystal z-axis in the depth direction of FIG. 7. The first wavelength conversion element 35 and the second wavelength conversion element 36 are in optical contact with each other.

The wavelength conversion element 30 is shaped like a cylinder having a length of, for example, 16 mm and a diameter of, for example, 1 mm. The wavelength conversion element 30 converts a fundamental wave into a converted wave having a different wavelength from the fundamental wave. One end face 32 of the wavelength conversion element 30 in the longitudinal directions is formed with a fundamental-wave inlet 31 for incidence of the fundamental wave. Both end faces 32 and 33 of the cylindrical wavelength conversion element 30 in the longitudinal directions are formed, except for the fundamental-wave inlet 31, with a fundamental-wave reflective coat for reflecting the fundamental wave.

The end face 33 is formed with the fundamental-wave reflective coat and a converted-wave transmission coat for transmitting the converted wave as a face for outputting the converted wave. The fundamental-wave inlet 31 is near an arc of the cylindrical end face 32, has a diameter of, for example, 100 μm and is formed with an AR coat for the fundamental wave. The end face 32 with the fundamental-wave inlet 31 has a plane shape while the other end face 33 in the longitudinal directions has a convex spherical shape. The curvature radius of the spherical end face 33 is, for example, 10 mm.

In the third embodiment, the end faces 32 and 33 of the wavelength conversion element 30 correspond to an example of the pair of fundamental-wave reflecting surfaces and the resin clad 14 corresponds to an example of the reflection portion.

The randomly-polarized fundamental-wave laser light source 39 emits a fundamental wave polarized at random. The fundamental wave emitted from the randomly-polarized fundamental-wave laser light source 39 is concentrated into the fundamental-wave inlet 31 by the condensing lens 2 and incident upon the wavelength conversion element 30 with inclined with respect to the axis of the cylindrical wavelength conversion element 30. The incident fundamental wave goes ahead in the longitudinal direction of the wavelength conversion element 30, and each polarization component thereof in the z-axis directions of PPMgLN undergoes a wavelength conversion in the first wavelength conversion element 35 and the second wavelength conversion element 36, respectively.

The fundamental wave is reflected by the spherical end face 33, thereafter reflected by the plane end face 32, the end face 33 and the side surface of the wavelength conversion element 30 and goes back and forth in the longitudinal direction of the wavelength conversion element 30. The fundamental wave is reflected by the spherical end face 33 and the side surface of the wavelength conversion element 30 and thereby crosses inside of the wavelength conversion element 30. The spherical end face 33 functions as a concave mirror for the fundamental wave, and the fundamental wave going back and forth forms a plurality of light-concentration points other than cross points.

The end face 32 and the side surface of the wavelength conversion element 30 reflect the converted wave as well, and the converted wave subjected to a wavelength conversion is emitted from the end face 33. The polarization direction of the fundamental wave changes through the reflection by the cylindrical side surface and the end face 33 of the wavelength conversion element 30. The wavelength conversion element 30 is formed by the two non-linear materials (first wavelength conversion element 35 and second wavelength conversion element 36) which have a crystal axis perpendicular to each other and thereby conducts a wavelength conversion regardless of the polarization direction. Besides, the wavelength conversion element 30 can convert the wavelength of the fundamental wave even if the polarization direction thereof changes while going back and forth between the fundamental-wave reflecting surfaces.

In the third embodiment, it is preferable that the wavelength conversion element 30 is formed by the two sections (first wavelength conversion element 35 and second wavelength conversion element 36) which have a crystal axis perpendicular to each other. The wavelength conversion element has the pair of fundamental-wave reflecting surfaces, the fundamental wave passes several times inside of the wavelength conversion element, and the polarization direction of the fundamental wave can be changed as it passes repeatedly. In the third embodiment, however, the fundamental wave can be certainly converted, though the polarization direction thereof changes while going back and forth between the fundamental-wave reflecting surfaces.

The configuration according to the third embodiment utilizing reflections by the curved surfaces is especially effective because the polarization is occasionally changed.

Further, in the case of a fundamental-wave laser light source emitting a beam of light polarized at random, the first wavelength conversion element 35 and the second wavelength conversion element 36 having a crystal axis perpendicular to each other are indispensable for enhancing the conversion efficiency.

### Fourth Embodiment

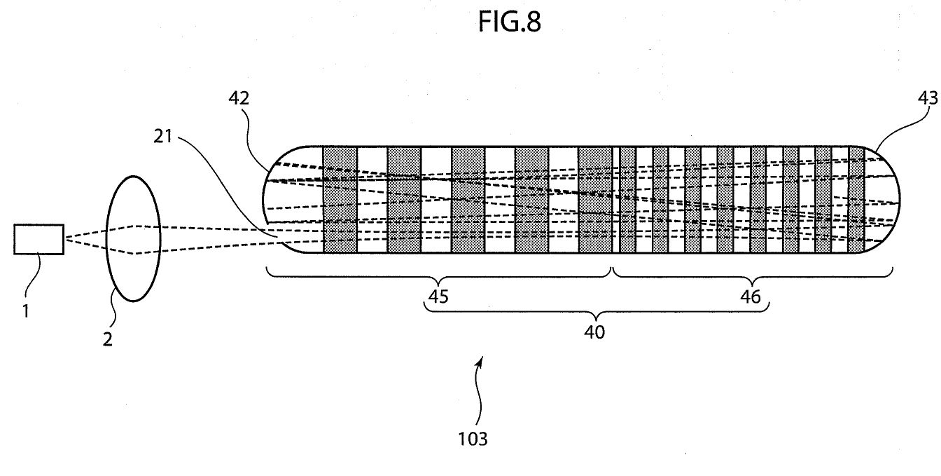

FIG. 8 is schematic top view showing a configuration of a wavelength converting laser 103 according to a fourth embodiment of the present invention. In the fourth embodiment, component elements are given the same reference characters and numerals as those of the first to third embodiments, as long as the former are identical to the latter, and thus, their description is omitted.

The wavelength converting laser 103 includes a fundamental-wave laser light source 1, a condensing lens 2 and a wavelength conversion element 40.

The wavelength conversion element 40 is made of an MgO:LiNbO₃ crystal having a polarization inversion period structure and is shaped like a rod having a length of, for example, 10 mm and a width and a thickness of, for example, 0.8 mm, respectively. The wavelength conversion element 40 includes two kinds of wavelength conversion elements (first wavelength conversion element 45 and second wavelength conversion element 46) which have a polarization inversion period different from each other. The polarization inversion period of the first wavelength conversion element 45 having an end face 42 is a double-wave generation period for generating a double wave and the polarization inversion period of the second wavelength conversion element 46 having an end face 43 is a triple-wave generation period for generating a triple wave. The polarization inversion period of the first wavelength conversion element 45 is designed so as to come into a quasi-phase matching condition for generating a double wave of the fundamental wave. The polarization inversion period of the second wavelength conversion element 46 is designed so as to come into a quasi-phase matching condition for generating a triple wave equivalent to the sum frequency of the fundamental wave and the double wave.

The wavelength conversion element 40 converts the fundamental wave into a converted wave (double wave and triple wave) having a different wavelength from the fundamental wave. The end face 42 of the wavelength conversion element 40 in the longitudinal directions is formed with a fundamental-wave inlet 21 for incidence of the fundamental wave.

The end face 42 of the rod-shaped wavelength conversion element 40 in the longitudinal directions is formed with a reflective coat for reflecting the fundamental wave and the double wave. The end face 43 is formed with a reflective coat for reflecting the fundamental wave and a transmission coat for transmitting the double wave and the triple wave as a face for outputting the double wave and the triple wave as the converted wave. The fundamental-wave inlet 21 is shifted toward the lateral end from the center of the end face 42, has a diameter of, for example, 90 μm and is formed with an AR coat for the fundamental wave. The shapes of the end face 42 and the end face 43 are the same as the end face 22 and the end face 23 according to the second embodiment.

The fundamental wave goes back and forth inside of the wavelength conversion element 40 in the same way as the second embodiment, crosses inside of the wavelength conversion element 40 and forms a plurality of light-concentration points at places different from a cross point of the fundamental wave.

The wavelength converting laser 103 is a wavelength converting laser outputting the double wave and the triple wave. The fundamental wave incident upon the fundamental-wave inlet 21 goes ahead in the longitudinal direction of the wavelength conversion element 40. The fundamental wave advancing through the first wavelength conversion element 45 is converted into a double wave, and the double wave obtained in the first wavelength conversion element 45 is accompanied by the fundamental wave, goes inside of the first wavelength conversion element 45 and is incident upon the second wavelength conversion element 46. The fundamental wave and the double wave incident upon the second wavelength conversion element 46 is converted into a triple wave, and the thus obtained double wave and triple wave are outputted from the end face 43. The fundamental wave is reflected by the spherical end face 43 goes ahead again inside of the wavelength conversion element 40.

The end face 42 and the end face 43 works as a concave mirror for the fundamental wave. The fundamental wave goes back and forth between the end face 42 and the end face 43 while forming a plurality of light-concentration points, and the fundamental wave going back and forth crosses inside of the wavelength conversion element 40, and however, also forms a plurality of light-concentration points at places different from a cross point. A double wave is generated when the fundamental wave goes ahead inside of the first wavelength conversion element 45, and a triple wave is generated when the fundamental wave together with the generated double wave goes through the second wavelength conversion element 46. The fundamental wave passes several times inside of the wavelength conversion element 40 to thereby generate the double wave and the triple wave repeatedly.

In the fourth embodiment, the end faces 42 and 43 of the wavelength conversion element 40 correspond to an example of the pair of fundamental-wave reflecting surfaces, and in the fourth embodiment, the side surface of the wavelength conversion element 40 may be coated with a resin clad.

In the fourth embodiment, it is preferable that a plurality of wavelength conversion elements having a mutually different phase matching period generate higher-order converted waves while the fundamental wave goes back and forth between the fundamental-wave reflecting surfaces. A conventional wavelength conversion into higher-order converted waves (such as triple to five-times waves) is extremely inefficient and requires a complex configuration.

In contrast, the wavelength conversion element 40 according to the fourth embodiment is capable of generating higher-order converted waves efficiently by generating a higher-order converted wave using a quasi-phase matching period when the fundamental wave and the converted wave make several passes inside thereof. Particularly, in the wavelength conversion element 40 according to the fourth embodiment, light-concentration points are dispersed to thereby disperse places where higher-order converted waves are generated, so that the higher-order converted waves can be prevented from causing optical absorption to thereby deteriorate the conversion efficiency and damage the wavelength conversion element 40.

In the fourth embodiment, the spherical end face 43 transmits the double wave and the triple wave, however it may be formed with a reflective coat reflecting the double wave in such a way that only the triple wave is transmitted.

The wavelength conversion element 40 leads the double wave to go back and forth between the pair of reflecting surfaces, thereby raising the power of the double wave and improving the efficiency of conversion into the triple wave.

### Fifth Embodiment

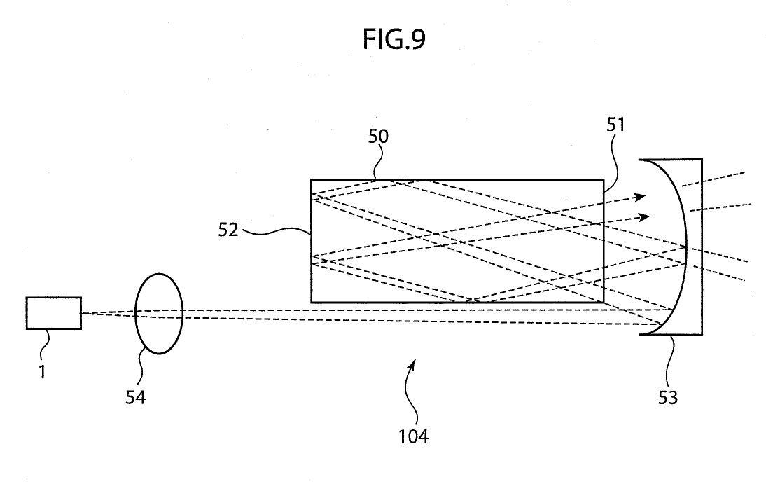

FIG. 9 is schematic top view showing a configuration of a wavelength converting laser 104 according to a fifth embodiment of the present invention. In the fifth embodiment, component elements are given the same reference characters and numerals as those of the first to fourth embodiments, as long as the former are identical to the latter, and thus, their description is omitted.

The wavelength converting laser 104 includes a fundamental-wave laser light source 1, a wavelength conversion element 50, a concave mirror 53 and a collimating lens 54.

The wavelength conversion element 50 is made of an MgO:LiNbO₃ crystal having a polarization inversion period structure and is shaped like a rectangular parallelepiped having a length of, for example, 10 mm, a width of, for example, 2 mm and a thickness of, for example, 1 mm. One end face 52 of the wavelength conversion element 50 is formed with a reflective coat for reflecting the fundamental wave and the converted wave and the other end face 51 in the longitudinal directions of the wavelength conversion element 50 is formed with a transmission coat for transmitting the fundamental wave and the converted wave. The concave mirror 53 is a spherical mirror having a curvature radius of 10 mm and is formed with a reflective coat reflecting the fundamental wave and a transmission coat for transmitting the converted wave. The concave mirror 53 is an output mirror for outputting the converted wave, and the end face 52 and the concave mirror 53 constitute a pair of fundamental-wave reflecting surfaces in the longitudinal directions of the wavelength conversion element 50.

A fundamental wave emitted from the fundamental-wave laser light source 1 is collimated by the collimating lens 54, thereafter reflected by the concave mirror 53 and incident upon the wavelength conversion element 50. The incident fundamental wave is reflected by the end face 52, the side faces of the wavelength conversion element 50 and the concave mirror 53 and passes a plurality of times inside of the wavelength conversion element 50. The fundamental wave passing inside of the wavelength conversion element 50 is converted into a converted wave and the obtained converted wave is outputted from the concave mirror 53. The concave mirror 53 with the above curvature concentrates the fundamental wave going back and forth between the reflecting surfaces to form a light-concentration point. Further, the fundamental wave is reflected by the side faces in the width directions of the wavelength conversion element 50 and thereby crosses inside of the wavelength conversion element 50.

In the fifth embodiment, the end face 52 of the wavelength conversion element 50 and the concave mirror 53 correspond to an example of the pair of fundamental-wave reflecting surfaces, and in the fifth embodiment, the side faces of the wavelength conversion element 50 may be coated with a resin clad.

In the fifth embodiment, using reflection by the concave mirror 53 and reflection by the side faces of the wavelength conversion element 50, the fundamental wave crosses inside of the wavelength conversion element 50 and forms a plurality of light-concentration points at places different from a cross point. This makes it possible to obtain a higher conversion efficiency while dispersing places where the power densities of the fundamental wave and the converted wave become higher and collect sections for emitting a plurality of beams into a single small section.

In the wavelength conversion element 50, a plurality of light-concentration points are formed near the end face 52 which is a reflecting surface with no curvature. The reflective coat of the end face 52 for reflecting the fundamental wave and the converted wave is formed by a laminated dielectric film in nine layers of MgF₂ and TiO₂ from the side of the wavelength conversion element 50 and a metal film made of aluminum and having a thickness of 200 nm evaporated onto the laminated dielectric film.

In the fifth embodiment, it is preferable that at least one of the pair of fundamental-wave reflecting surfaces includes a reflective film for reflecting the fundamental wave and the converted wave, the plurality of light-concentration points are formed near the reflective film, and the reflective film includes a metal film having a thickness of 100 nm or above. In the wavelength conversion element 50, the plurality of light-concentration points are formed near the end face 52, and the end face 52 has the reflective coat includes a metal film having a thickness of 100 nm or above which reflects the fundamental wave and the converted wave. The light-concentration points cause intense optical absorption and local heat generation, and the metal film near the light-concentration points functions as a heat transfer route and thereby suppresses a local rise in the temperature of the wavelength conversion element 50.

Accordingly, the reflective film with the metal film is useful for avoiding element destruction and fall in the conversion efficiency which can be caused when the temperature of the wavelength conversion element 50 goes up.

The metal film functions as a heat transfer route and thus requires a thickness of 100 nm or above. Preferably, the metal film may be directly connected to a metal heat sink, thereby securing a heat transfer route.

### Sixth Embodiment

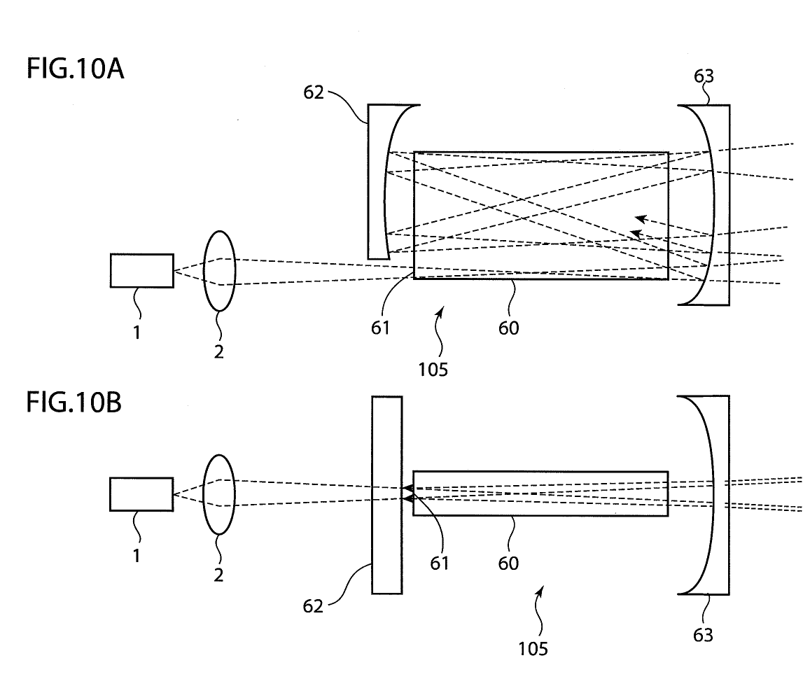

FIG. 10A is schematic top view showing a configuration of a wavelength converting laser 105 according to a sixth embodiment of the present invention and FIG. 10B is schematic side view showing a configuration of the wavelength converting laser 105 according to the sixth embodiment of the present invention. In the sixth embodiment, component elements are given the same reference characters and numerals as those of the first to fifth embodiments, as long as the former are identical to the latter, and thus, their description is omitted.

The wavelength converting laser 105 includes a fundamental-wave laser light source 1, a condensing lens 2, a wavelength conversion element 60, a cylindrical mirror 62 and a concave mirror 63.

The wavelength conversion element 60 is made of an MgO:LiNbO₃ crystal having a polarization inversion period structure and is shaped like a rectangular parallelepiped having a length of, for example, 25 mm, a width of, for example, 4 mm and a thickness of, for example, 1 mm. Both end faces in the longitudinal directions of the wavelength conversion element 60 is formed with an AR coat for the fundamental wave and the converted wave.

The wavelength conversion element 60 converts the fundamental wave into a converted wave having a different wavelength from the fundamental wave. One end face of the wavelength conversion element 60 in the longitudinal directions is formed with a fundamental-wave inlet 61 for incidence of the fundamental wave.

The cylindrical mirror 62 partly cut so as to correspond to the position of the fundamental-wave inlet 61 of the wavelength conversion element 60 is arranged near the end face in the longitudinal directions of the wavelength conversion element 60 on the side of the fundamental-wave laser light source 1. The cylindrical mirror 62 has a reflective coat for reflecting the fundamental wave and the converted wave and has a curvature in the width directions of the wavelength conversion element 60 whose curvature radius is, for example, 20 mm. In order for the fundamental wave to be incident upon the fundamental-wave inlet 61 located at the end of the wavelength conversion element 60 in the width directions, the section of the cylindrical mirror 62 corresponding to the incidence optical path of the fundamental wave is cut off.

On the other hand, the spherical concave mirror 63 is arranged near the other end face in the longitudinal directions of the wavelength conversion element 60. The concave mirror 63 has a curvature radius of, for example, 22 mm and has a reflective coat for reflecting the fundamental wave and a transmission coat for transmitting the converted wave. The concave mirror 63 is an output mirror for outputting the converted wave, and the cylindrical mirror 62 and the concave mirror 63 constitute a pair of fundamental-wave reflecting surfaces. The distance between the fundamental-wave reflecting surfaces is approximately 21 mm in air-reduced length.

A fundamental wave emitted from the fundamental-wave laser light source 1 is concentrated by the condensing lens 2, incident from the fundamental-wave inlet 61 upon the wavelength conversion element 60, concentrated inside of the wavelength conversion element 60, thereafter reflected by the concave mirror 63 and again incident upon the wavelength conversion element 60. The fundamental wave which has passed through the wavelength conversion element 60 is reflected by the cylindrical mirror 62 and again incident upon the wavelength conversion element 60. The fundamental wave goes back and forth a plurality of times between the cylindrical mirror 62 and the concave mirror 63 and is converted into a converted wave when passing through the wavelength conversion element 60, and the converted wave is outputted from the concave mirror 63.

The concave mirror 63 and the cylindrical mirror 62 refract the fundamental wave and lead it to cross inside of the wavelength conversion element 60, and the condensing lens 2, the concave mirror 63 and the cylindrical mirror 62 allows it to form a plurality of light-concentration points.

The cylindrical mirror 62 causes the fundamental wave to form the light-concentration points different from each other in the beam-diameter directions. At this time, the beam diameter in the thickness directions of the wavelength conversion element 60 becomes a stable resonance condition, thereby keeping the beam diameter constant even though the beam goes back and forth repeatedly. The condensing lens 2, the concave mirror 63 and the cylindrical mirror 62 lead the fundamental wave to form the plurality of light-concentration points at places different from a cross point of the fundamental wave.

In the sixth embodiment, the cylindrical mirror 62 and the concave mirror 63 correspond to an example of the pair of fundamental-wave reflecting surfaces, and in the sixth embodiment, the side faces of the wavelength conversion element 60 may be coated with a resin clad.

In the sixth embodiment, the fundamental wave passes several times through the wavelength conversion element 60, crosses inside of the wavelength conversion element 60 and forms the plurality of light-concentration points at places different from a cross point. This makes it possible to obtain a higher conversion efficiency while dispersing places where the power densities of the fundamental wave and the converted wave become higher and collect sections for emitting a plurality of beams into a single small section.

In the sixth embodiment, it is preferable that one of the pair of fundamental-wave reflecting surfaces is a cylindrical surface and the other is a spherical surface.

Since the one fundamental-wave reflecting surface is a cylindrical surface, both fundamental-wave reflecting surfaces are capable of concentrating light and the different light-concentration points in the beam-diameter directions are formed, thereby dispersing places where the power densities of the fundamental wave and the converted wave become higher.

Further, since the cylindrical surface is employed, the beam diameter in the one direction becomes a stable resonance condition, thereby preventing the beam diameter from widening because of diffraction when the fundamental wave goes back and forth. This makes it possible to suppress an increase in the beam diameter and thereby a decline in the conversion efficiency as the fundamental wave goes back and forth more times.

### Seventh Embodiment

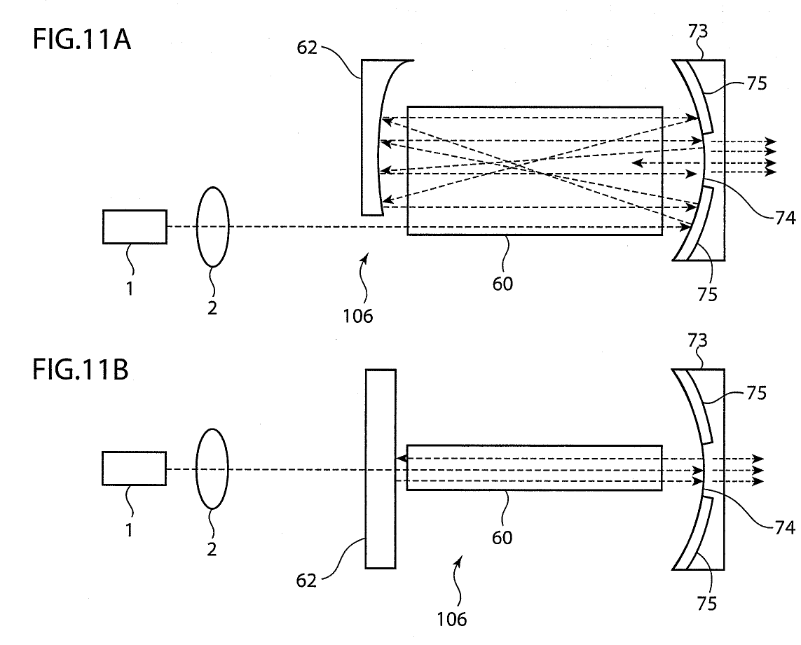

FIG. 11A is schematic top view showing a configuration of a wavelength converting laser 106 according to a seventh embodiment of the present invention and FIG. 11B is schematic side view showing a configuration of the wavelength converting laser 106 according to a seventh embodiment of the present invention. In the seventh embodiment, component elements are given the same reference characters and numerals as those of the first to sixth embodiments, as long as the former are identical to the latter, and thus, their description is omitted.

The wavelength converting laser 106 includes a fundamental-wave laser light source 1, a condensing lens 2, a wavelength conversion element 60, a cylindrical mirror 62 and a concave mirror 73.

The wavelength converting laser 106 is configured by the same component elements as the wavelength converting laser 105 according to the sixth embodiment, except for the concave mirror 73. The concave mirror 73 includes a converted-wave transmission portion (transmission region) 74 formed only within a diameter of 1 mm in the middle thereof and having a coat for reflecting the fundamental wave and transmitting the converted wave, and a converted-wave reflection portion (reflection region) 75 formed in the periphery part of the converted-wave transmission portion 74 and having a coat for reflecting both the fundamental wave and the converted wave. The converted wave generated when the fundamental wave passes inside of the wavelength conversion element 60 is outputted outside only from the converted-wave transmission portion 74.

In the seventh embodiment, the cylindrical mirror 62 and the concave mirror 73 correspond to an example of the pair of fundamental-wave reflecting surfaces, and in the seventh embodiment, the side faces of the wavelength conversion element 60 may be coated with a resin clad.

In the seventh embodiment, it is preferable that the section of a fundamental-wave reflecting surface which transmits the converted wave is only one region of the fundamental-wave reflecting surface, and the fundamental wave and the converted wave are reflected in the other region.

In the seventh embodiment, the fundamental-wave reflecting surfaces reflect the converted wave to thereby incline the optical path thereof, and the converted wave undergoes a change in the optical path every time it is reflected. The transmission section transmitting the converted wave is the single region of the fundamental-wave reflecting surface, thereby outputting the converted wave only when reaching the transmission section. Since the converted wave is emitted only from the transmission region, a plurality of converted-wave beams are emitted from the limited transmission region, thereby significantly reducing the area of the converted-wave emission region, so that a plurality of converted-wave beams can be handled as a single fine luminous flux.

### Eighth Embodiment

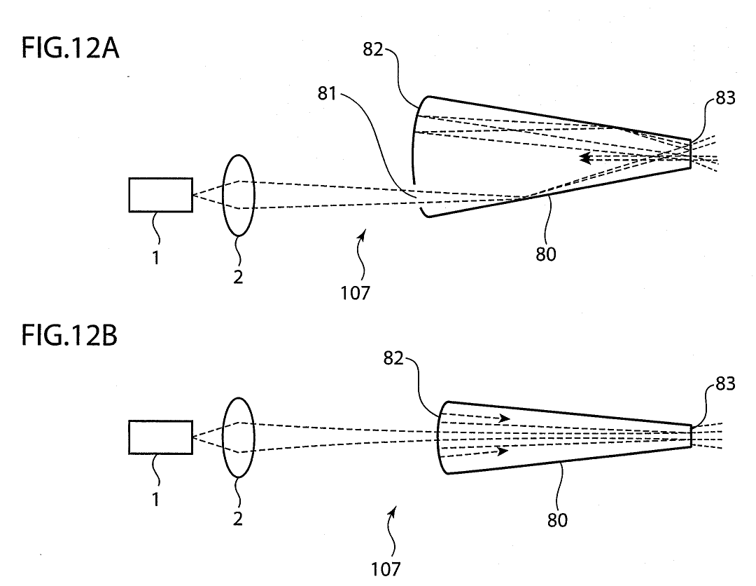

FIG. 12A is schematic top view showing a configuration of a wavelength converting laser 107 according to an eighth embodiment of the present invention and FIG. 12B is schematic side view showing a configuration of the wavelength converting laser 107 according to an eighth embodiment of the present invention. In the eighth embodiment, component elements are given the same reference characters and numerals as those of the first to seventh embodiments, as long as the former are identical to the latter, and thus, their description is omitted.

The wavelength converting laser 107 includes a fundamental-wave laser light source 1, a condensing lens 2 and a wavelength conversion element 80.

The wavelength conversion element 80 is made of an MgO:LiTaO₃ crystal having a polarization inversion period structure and is shaped like a pillar in which the area of an end face 82 for incidence of the fundamental wave is larger than the area of an end face 83 for emission of the converted wave on the opposite side and the side faces have a trapezoidal shape in section. The wavelength conversion element 80 has a length of, for example, 10 mm, the end face 82 is shaped like a rectangle having a width of, for example, 4 mm and a thickness of, for example, 2 mm and the end face 83 is shaped like a rectangle having a width of, for example, 1 mm and a thickness of, for example, 0.75 mm.

The end face 82 is a convex spherical surface, has a curvature radius of, for example, 24 mm and is formed, except for a fundamental-wave inlet 81, with a reflective coat for reflecting the fundamental wave and the converted wave. The end face 83 is a plane surface and is formed with a reflective coat for reflecting the fundamental wave and a transmission coat for transmitting the converted wave. The side faces of the wavelength conversion element 80 reflect the fundamental wave and the converted wave totally. The fundamental-wave inlet 81 is formed with a transmission coat for transmitting the fundamental wave, has a diameter of, for example, 200 μm and is shifted widthwise, for example, by 1.2 mm from the center of the end face 82. The spherical end face 82 and the plane end face 83 in the longitudinal directions of the wavelength conversion element 80 are a pair of fundamental-wave reflecting surfaces. The converted wave is emitted with a plurality of beams thereof overlapping each other from the end face 83.

A fundamental wave emitted from the fundamental-wave laser light source 1 is concentrated into the fundamental-wave inlet 81 by the condensing lens 2 and incident upon the wavelength conversion element 80, goes ahead in the longitudinal direction of the wavelength conversion element 80, is reflected by the side faces, the end face 83 and the end face 82, and thereby goes back and forth between the end face 82 and the end face 83. The fundamental wave going back and forth crosses at several places, and the capabilities of the condensing lens 2 and the spherical end face 82 to concentrate light lead the fundamental wave to form a plurality of light-concentration points.

At this time, the wavelength conversion element 80 forms a plurality of light-concentration points at places different from a cross point of the fundamental wave and generates a converted wave from the fundamental wave going ahead inside thereof. A plurality of converted-wave beams are outputted with overlapping each other from the plane end face 83. Since the area of the end face 83 on one side for the output is smaller than the area of the end face 82 on the other side, a large number of converted-wave beams are emitted from the end face 83 after reflected by the side faces of the wavelength conversion element 80. The thus outputted converted wave has a uniform intensity distribution.

In the eighth embodiment, the end faces 82 and 83 of the wavelength conversion element 80 correspond to an example of the pair of fundamental-wave reflecting surfaces, and in the eighth embodiment, the side faces of the wavelength conversion element 80 may be coated with a resin clad.

In the eighth embodiment, it is preferable that the end face 83 on one side of the wavelength conversion element 80 is formed with the coats for reflecting the fundamental wave and for transmitting the converted wave, and the area of the end face 83 on one side is smaller than the area of the end face 82 on the other side. Since the area of the end face 83 for emission of the converted wave is smaller than the area of the end face 82 for incidence of the fundamental wave, the converted wave is outputted with a plurality of beams thereof overlapping each other when emitted. The outputted converted-wave beams are superimposed on each other, thereby unifying the intensity distribution to enable the wavelength converting laser 107 to serve directly in the field of machining, illumination or the like. Besides, the smaller converted-wave emission area is useful in miniaturizing an optical part employed for the converted wave.

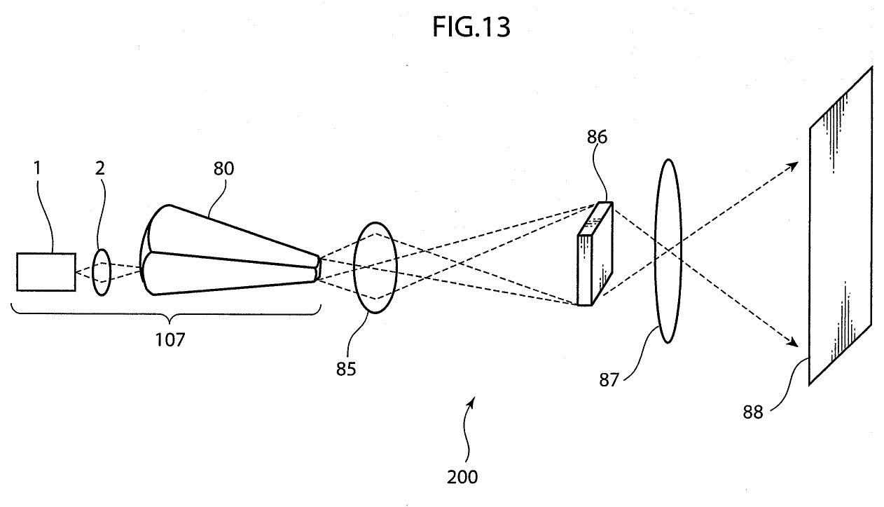

FIG. 13 is schematic view showing a configuration of an image display 200 including the wavelength converting laser 107 of FIGS. 12A and 12B. The image display 200 includes the wavelength converting laser 107, an image-casting optical system 85, a spatial modulation element 86, a projection optical system 87 and a display surface 88.

The converted wave emitted from the end face 83 of the wavelength converting laser 107 is rectangular and has a uniform intensity distribution. The image-casting optical system 85 enlarges and projects the converted wave emitted from the end face 83 onto the spatial modulation element 86. The spatial modulation element 86 has a rectangular shape analogous to the end face 83 having a width-height ratio of 4:3. The spatial modulation element 86 is formed, for example, by a transmission-type liquid crystal and a deflecting plate, modulates a laser beam of each color and emits the laser beam modulated into two dimensions. The projection optical system 87 projects the laser beam modulated by the spatial modulation element 86 onto the display surface 88.

In the eighth embodiment, it is preferable that an image of the end face 83 transmitting the converted wave of both end faces of the wavelength conversion element 80 in the wavelength converting laser 107 is projected on the spatial modulation element 86 modulating the converted wave.

In the eighth embodiment, the converted wave made up of a plurality of beams is shaped according to the shape of the end face 83 of the wavelength conversion element 80 in the wavelength converting laser 107, and the plurality of converted-wave beams overlaps each other, thereby unifying the intensity distribution. In accordance with the characteristics of the wavelength converting laser 107, the image of the end face 83 of the wavelength conversion element 80 is projected on the spatial modulation element 86, thereby making the converted wave efficiently usable. Since there is no need to provide any optical part for beam shaping, a loss caused by beam shaping can be suppressed and the number of necessary optical parts reduced. The image-casting optical system 85 may be further provided, in addition to a lens, with a diffusion plate for adjusting the intensity distribution or the like.

Preferably, the image display 200 may include the wavelength converting laser and a modulation element modulating the converted wave emitted from the wavelength converting laser. The wavelength converting laser emits a plurality of wavelength-converted beams within a specified angle from end face of a small area, thereby leading the converted wave extremely efficiently to the modulation element.

This makes it possible to realize an image display capable of utilizing light efficiently and thereby reduce the power consumption of the whole image display 200. Particularly, it can be effectively used as an image display making a display having a width across-corner of 30 inches or above whose electric power is mostly consumed by a light source thereof.

In addition to a spatial modulation element such as a transmission-type or reflection-type liquid-crystal element, the modulation element includes an element such as a scanning mirror which scans a beam of light to thereby modulate a place where the beam is to be displayed.

The image display 200 can be applied to a projector, a liquid-crystal display, a head-up display and the like.

Furthermore, the image display 200 is provided with the wavelength converting laser 107 according to the eighth embodiment, but the present invention is not limited especially to this, and thus, the wavelength converting laser 107 may be replaced with the wavelength converting lasers 100 to 106 according to the first to seventh embodiments and wavelength converting lasers 108 and 109 according to ninth and tenth embodiments of the present invention described later.

### Ninth Embodiment

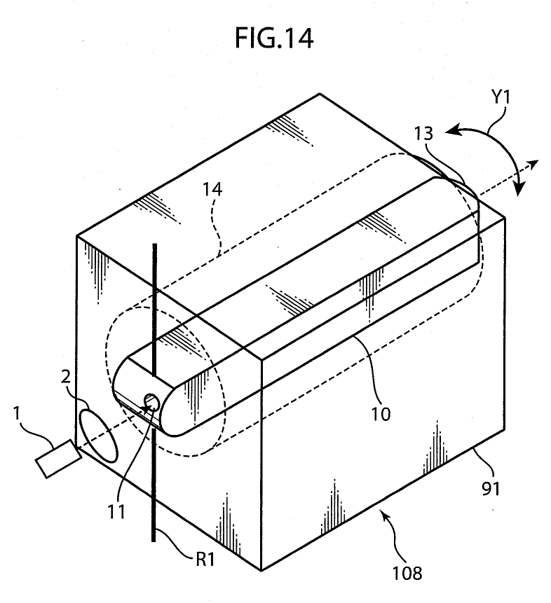

FIG. 14 is schematic view showing a configuration of a wavelength converting laser 108 according to a ninth embodiment of the present invention. In the ninth embodiment, component elements are given the same reference characters and numerals as those of the first to eighth embodiments, as long as the former are identical to the latter, and thus, their description is omitted.

The wavelength converting laser 108 includes a fundamental-wave laser light source 1, a condensing lens 2, a wavelength conversion element 10, a resin clad 14 and a vibration mechanism 91.

The wavelength converting laser 108 is configured by attaching the vibration mechanism 91 operating the wavelength conversion element 10 during the emission of a laser beam to the wavelength converting laser 100 according to the first embodiment. The vibration mechanism 91 turns and vibrates the wavelength conversion element 10 in lateral directions Y1 around a turning axis R1 intersecting the incidence direction of a fundamental wave upon a fundamental-wave inlet 11. The vibration mechanism 91 is attached to the resin clad 14, formed by, for example, an electro-magnetic coil and swings an end face 13 emitting a converted wave at a wavelength of 0.2 mm and a frequency of 200 Hz.

The wavelength conversion element 10 generates the converted wave from the fundamental wave going ahead inside thereof, and the quantity of the converted wave generated through a one-way optical path between fundamental-wave reflecting surfaces is determined based on the beam intensity and the gap from a phase matching condition. The wavelength conversion element 10 moves slightly, thereby varying the angle of each optical path of the fundamental wave as time elapses to change the gap from a phase matching condition.

A plurality of converted-wave beams generated through each optical path are superimposed on each other and emitted from the emission end face 13.

The intensity distribution of the emitted converted wave varies as time passes because of variation in the quantity of the converted wave generated through each optical path, thereby changing the interference condition of the emitted converted wave as well along with the elapse of time. This means that the interference pattern changes as time passes, and thus, a time integral is executed to thereby unify and reduce the interference noise, particularly, a speckle noise caused in the field of display and illumination. Although the converted-wave intensity distribution changes, each optical path is related so as to compensate for a conversion efficiency, thereby evading a significant variation in the total output of the converted wave.

In the ninth embodiment, it is preferable that the wavelength conversion element 10 is vibrated during emission of the converted wave. The wavelength conversion element 10 moves slightly during the emission, thereby reducing the interference noise of the outputted converted wave. In the ninth embodiment, although the converted wave made up of a plurality of beams generated through each optical path are superimposed and outputted, the converted-wave intensity distribution is changed as time elapses, thereby reducing the interference noise. In the ninth embodiment, each fundamental-wave optical path compensates a decline in the conversion efficiency, thereby evading a sharp variation in the total output of the converted wave, though the intensity distribution thereof varies.

### Tenth Embodiment

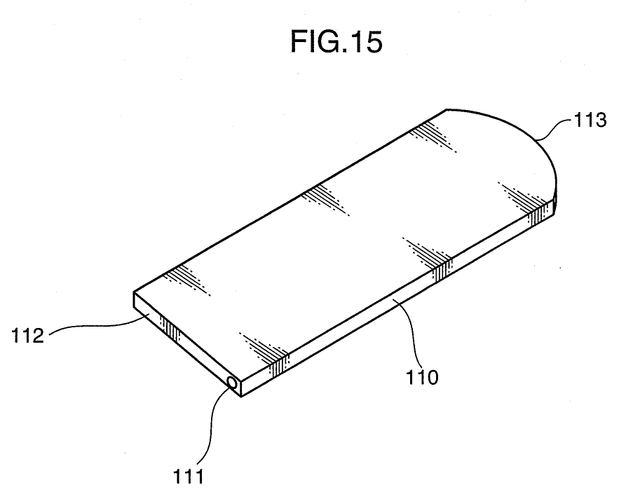

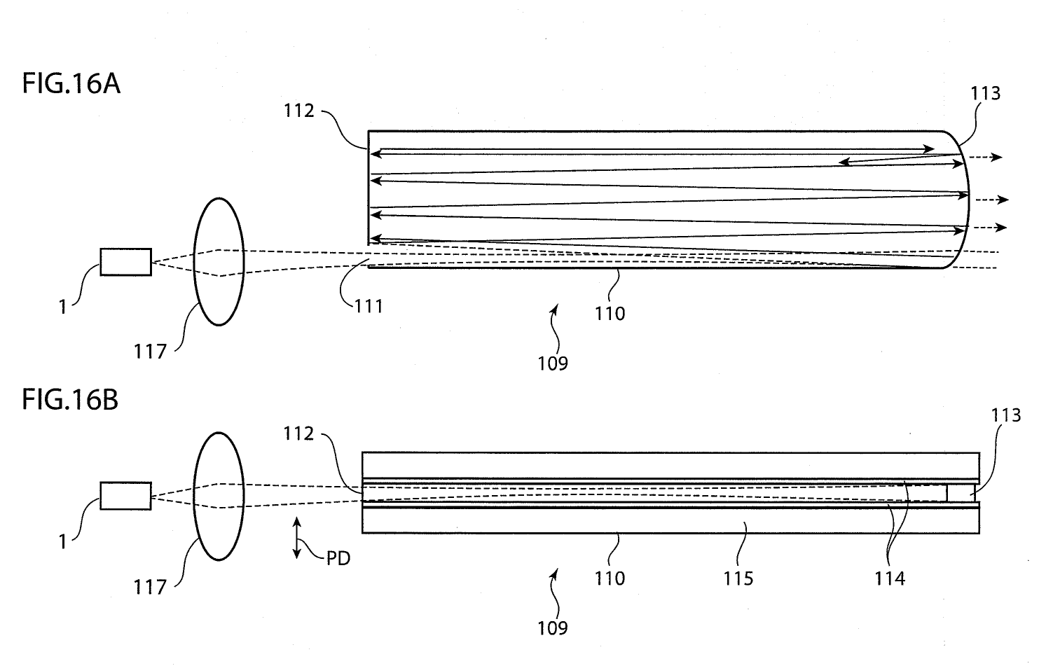

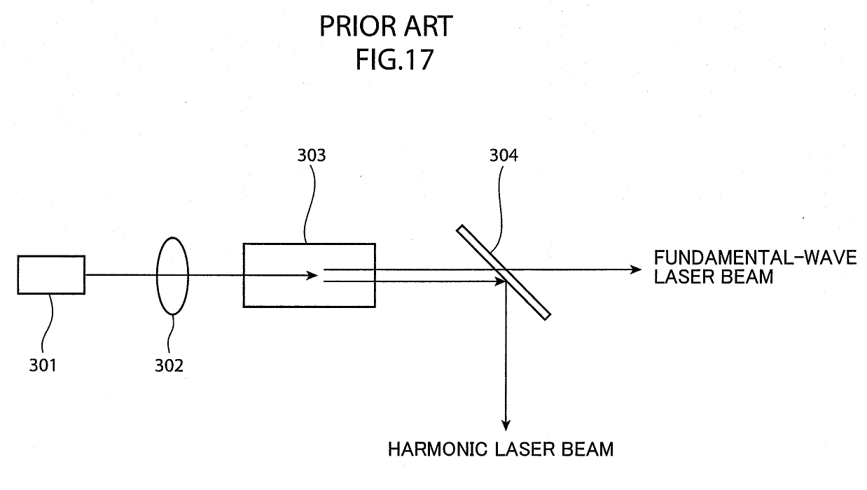

FIG. 15 is a schematic view showing an exterior shape of a wavelength conversion element 110 according to a tenth embodiment of the present invention. FIG. 16A is a schematic top view showing a configuration of a wavelength converting laser 109 according to the tenth embodiment of the present invention and FIG. 16B is a schematic side view showing a configuration of the wavelength converting laser 109 according to the tenth embodiment of the present invention. In the tenth embodiment, component elements are given the same reference characters and numerals as those of the first to ninth embodiments, as long as the former are identical to the latter, and thus, their description is omitted.

The wavelength converting laser 109 includes a fundamental-wave laser light source 1, the wavelength conversion element 110, a resin clad 114, a metal holder 115, and a condensing lens 117. The wavelength conversion element 110 converts a fundamental wave into a converted wave having a different wavelength from the fundamental wave.

One end face 112 of the wavelength conversion element 110 in the longitudinal directions is formed with a fundamental-wave inlet 111 for incidence of the fundamental wave.

The wavelength conversion element 110 is made of MgO:LiNbO₃ crystal having a polarization inversion period structure and is shaped like a flat plate having a length of, for example, 10 mm, a width of, for example, 5 mm and a thickness of, for example, 20 μm. The wavelength conversion element 110 is covered in the thickness directions with the resin clad 114 and functions as a multi-mode slab optical waveguide. Both end faces of the wavelength conversion element 110 in the longitudinal directions are formed, except for the fundamental-wave inlet 111, with a reflective coat for reflecting the fundamental wave.

The other end face 113 without the fundamental-wave inlet 111 is formed with a reflective coat for reflecting the fundamental wave and a transmission coat for transmitting the converted wave as a face for outputting the converted wave. The end face 112 for incidence of the fundamental wave is formed with a reflective coat for reflecting the converted wave. Hence, the wavelength converting laser 109 includes the output face only in the end face 23. The fundamental-wave inlet 111 is shifted laterally from the center of the end face 112 having a plane shape, has a size of, for example, 100 μm×20 μm and is formed with an AR coat for the fundamental wave.

The one end face 112 with the fundamental-wave inlet 111 has a plane shape while the other end face 113 has a convex cylindrical shape bent in the lateral directions of FIG. 15 and a curvature radius of, for example, 200 mm. The wavelength conversion element 110 is fixed via the resin clad 114 on the metal holder 115 and radiates heat through the metal holder 115. The condensing lens 117 concentrates a beam of light in such a way that the beam is incident upon the fundamental-wave inlet 111.

The wavelength conversion element 110 as the slab optical waveguide guides the fundamental wave, and leads the fundamental wave to reflect at the end face 112 and the end face 113, go back and forth repeatedly and change the optical path, and form a light-concentration point and cross.

The converted wave converted from the fundamental wave inside of the wavelength conversion element 110 is emitted from the end face 113.

In the tenth embodiment, the end faces 112 and 113 of the wavelength conversion element 110 correspond to an example of the pair of fundamental-wave reflecting surfaces.

In the wavelength converting laser 109, preferably, the wavelength conversion element 110 may be a slab optical waveguide reflecting the fundamental wave and the converted wave totally at the side faces thereof. In the tenth embodiment, specifically, it is preferable that the wavelength conversion element 110 is shaped like a flat plate having a predetermined thickness, and the resin clad 114 is arranged on two faces having the largest area and facing each other in the flat plate wavelength conversion element 110. The fact that the wavelength conversion element 110 is a slab optical waveguide makes it possible to keep a fundamental-wave beam from spreading in the thickness directions, thereby maintaining the light intensity at a high level even if the fundamental wave reflects repeatedly inside of the wavelength conversion element 110.

Therefore, the wavelength conversion efficiency can be enhanced for any optical paths of the fundamental wave.

Particularly, in the tenth embodiment, preferably, the wavelength conversion element 110 may have the function of a multi-mode slab optical waveguide. In the tenth embodiment, most of the fundamental wave incident upon the wavelength conversion element 110 is converted while being repeatedly reflected, and hence, it is important to heighten the beam coupling efficiency of the wavelength conversion element 110 and thereby equip the wavelength conversion element 110 with the multi-mode optical waveguide function capable of easily improving the beam coupling efficiency. Further, the multi-mode optical waveguide function is useful in expanding the allowable temperature range of the wavelength conversion element 110 because of the difference in phase matching condition according to the mode.

The resin clad 114 between the wavelength conversion element 110 and the metal holder 115 has a thickness of, for example, 5 μm, and preferably, 10 μm or below. The thinner the resin clad 114 becomes, the lower the thermal resistance becomes and the more heat generated from the wavelength conversion element 110 the metal holder 115 can radiate. Particularly, if the fundamental wave and the converted wave have a high power, the heat of the wavelength conversion element 110 can be more effectively radiated. If the allowable temperature range of the wavelength conversion element 110 is wide, there is no need to control the temperature especially using a Peltier element or the like, and hence, the radiation mechanism of the metal holder 115 is enough.

The present invention is not limited to the above first to tenth embodiments, variations can be suitably expected without departing from the scope of the present invention.

It is a matter of course that a combination can be employed of each first to tenth embodiment according to the present invention.

In the first to tenth embodiments, a part of light-concentration points of fundamental wave formed inside of the wavelength conversion element may overlap a cross point of the fundamental wave. As far as most of the light-concentration points of the fundamental wave do not coincide with the cross point of the fundamental wave, any arrangement may be used.

Herein, the above specific embodiments mainly include inventions having configurations as follows.

A wavelength converting laser according to an aspect of the present invention includes: a light source emitting a fundamental wave; and a wavelength conversion element converting the fundamental wave emitted from the light source into a converted wave having a different wavelength from the fundamental wave, in which: a pair of fundamental-wave reflecting surfaces is arranged on both end sides of the wavelength conversion element in the directions of an optical axis thereof and reflects the fundamental wave to thereby pass the fundamental wave a plurality of times inside of the wavelength conversion element, and at least one of the fundamental-wave reflecting surfaces transmits the converted wave; and the pair of fundamental-wave reflecting surfaces allows the fundamental wave to cross inside of the wavelength conversion element and form a plurality of light-concentration points at places different from a cross point of the fundamental wave.

According to this configuration, the pair of fundamental-wave reflecting surfaces allows the fundamental wave to pass a plurality of times inside of the wavelength conversion element, cross inside of the wavelength conversion element and form a plurality of light-concentration points at places different from a cross point of the fundamental wave.

Therefore, the fundamental wave passes a plurality of times inside of the wavelength conversion element and forms a plurality of light-concentration points at places different from a cross point of the fundamental wave, thereby making it possible to obtain a high conversion efficiency stably and reduce the light-source area of a converted wave emitted as a plurality of beams, resulting in the whole apparatus being smaller.

In the above wavelength converting laser, it is preferable that the side faces of the wavelength conversion element reflect the fundamental wave into the wavelength conversion element.

According to this configuration, the side faces of the wavelength conversion element reflect the fundamental wave into the wavelength conversion element. This makes it possible to keep the area within a specified range which the fundamental wave passes inside of the wavelength conversion element through and unify the intensity distribution of the fundamental wave passing through the wavelength conversion element to thereby disperse the places having higher fundamental-wave power densities.

Furthermore, preferably, the above wavelength converting laser may further include a reflection portion made of a material having a refractive index lower than the wavelength conversion element and coating the side faces of the wavelength conversion element.

According to this configuration, the side faces of the wavelength conversion element are coated with a reflection portion made of a material having a refractive index lower than the wavelength conversion element. Therefore, the fundamental wave and the converted wave can be totally reflected by the side faces of the wavelength conversion element and thereby returned inside of the wavelength conversion element.

Moreover, preferably, the above wavelength converting laser may further include a temperature regulator regulating the temperature of the wavelength conversion element via the reflection portion.

According to this configuration, the temperature of the wavelength conversion element can be regulated via the reflection portion, thereby preventing the fundamental wave and the converted wave from being absorbed into the temperature regulator and hence executing precise temperature control.

In addition, in the above wavelength converting laser, it is preferable that: the wavelength conversion element has a rectangular shape in a section crossing the optical axis thereof; and the direction of a polarization of the fundamental wave is parallel to a side of the section.

According to this configuration, the side faces of the wavelength conversion element reflecting the fundamental wave are parallel or perpendicular to the polarization directions, thereby removing a change in the polarization directions caused by the reflection to make the wavelength conversion efficient.

Furthermore, in the above wavelength converting laser, it is preferable that: the pair of fundamental-wave reflecting surfaces is formed in both end faces of the wavelength conversion element, respectively, in the optical-axis directions thereof; and at least one of both end faces of the wavelength conversion element has a convex shape.

According to this configuration, the convex end face of the wavelength conversion element works as a concave mirror for the fundamental wave to be reflected to thereby form a light-concentration point inside of the wavelength conversion element. On the other hand, the convex end face of the wavelength conversion element reflecting the fundamental wave and transmitting the converted wave works as a convex lens for the converted wave to thereby narrow the divergence angle of the converted wave to be emitted.

Moreover, in the above wavelength converting laser, preferably, at least one of both end faces of the wavelength conversion element may have a convex cylindrical shape.

This configuration causes light-concentration points formed inside of the wavelength conversion element to differ in the beam-diameter directions, thereby preventing the power density of the fundamental wave from concentrating.

In addition, in the above wavelength converting laser, it is preferable that one of the pair of fundamental-wave reflecting surfaces includes a cylindrical surface and the other includes a spherical surface.

According to this configuration, one of both end faces of the wavelength conversion element is a cylindrical surface, thereby evading beam diffraction and preventing the beam diameter from widening while the fundamental wave goes back and forth between the pair of fundamental-wave reflecting surfaces.

Furthermore, in the above wavelength converting laser, it is preferable that: the pair of fundamental-wave reflecting surfaces is formed in both end faces of the wavelength conversion element, respectively, in the optical-axis directions thereof; and one end face reflecting the fundamental wave and transmitting the converted wave of both end faces of the wavelength conversion element has an area smaller than the other end face.

According to this configuration, one end face reflecting the fundamental wave and transmitting the converted wave of both end faces of the wavelength conversion element has an area smaller than the other end face. This makes it possible to output the converted wave with a plurality of beams thereof overlapping each other, thereby unifying the intensity distribution.

Moreover, in the above wavelength converting laser, preferably, the wavelength conversion element may have a thickness and a width of 1 mm or below.

According to this configuration, the wavelength conversion element may have a thickness and a width of 1 mm or below and the light-source area of the converted wave is within a range of 1 mm×1 mm, thereby collecting the converted wave within a range narrow enough.

In addition, in the above wavelength converting laser, it is preferable that: the wavelength conversion element is a flat plate having a predetermined thickness; and the reflection portion is formed in two largest-area faces facing each other of the wavelength conversion element shaped like the flat plate.

This configuration makes it possible to keep a fundamental-wave beam from spreading in the thickness directions, thereby maintaining the light intensity at a high level even if the fundamental wave reflects repeatedly inside of the wavelength conversion element.

Furthermore, in the above wavelength converting laser, it is preferable that: the pair of fundamental-wave reflecting surfaces is formed in both end faces of the wavelength conversion element, respectively, in the optical-axis directions thereof; and one end face of both end faces of the wavelength conversion element reflects the fundamental wave and transmits the converted wave, and is connected to a multi-mode optical fiber propagating the converted wave.

According to this configuration, although a plurality of converted-wave beams are emitted from the wavelength conversion element, the plurality of converted-wave beams are incident as a single luminous flux directly to the multi-mode optical fiber, thereby easily transmitting the converted wave to various places.

Moreover, in the above wavelength converting laser, preferably, the connection end face of the multi-mode optical fiber to the wavelength conversion element may reflect the fundamental wave and transmit the converted wave.

This configuration makes it possible to separate the fundamental wave leaking from the end face of the wavelength conversion element and the converted wave and thereby transfer only the converted wave.

In addition, in the above wavelength converting laser, preferably, the fundamental-wave reflecting surface transmitting the converted wave may include a transmission region for transmitting the converted wave and a reflection region for reflecting both the fundamental wave and the converted wave.

According to this configuration, since the converted wave is emitted only from the transmission region, a plurality of converted-wave beams are emitted from the limited transmission region, thereby significantly reducing the area of the converted-wave emission region, so that a plurality of converted-wave beams can be handled as a single fine luminous flux.

Furthermore, preferably, the above wavelength converting laser may further include a vibration mechanism vibrating the wavelength conversion element when the converted wave is emitted.

According to this configuration, the wavelength conversion element vibrates during the emission of the converted wave, thereby reducing the interference noise of the outputted converted wave.

Moreover, in the above wavelength converting laser, preferably, an image of an end face transmitting the converted wave of both end faces of the wavelength conversion element may be projected on a modulation element modulating the converted wave.

This configuration makes it possible to shape a plurality of converted-wave beams according to the shape of the end face of the wavelength conversion element and overlap the plurality of converted-wave beams to thereby unify the intensity distribution. Besides, since there is no need to provide any optical part for beam shaping, a loss caused by beam shaping can be suppressed and the number of necessary optical parts reduced.

In addition, in the above wavelength converting laser, it is preferable that: at least one of the pair of fundamental-wave reflecting surfaces includes a reflective film for reflecting the fundamental wave and the converted wave; the plurality of light-concentration points are formed near the reflective film; and the reflective film includes a metal film having a thickness of 100 nm or above.

According to this configuration, the metal film having a thickness of 100 nm or above functions as a heat transfer route and thereby suppresses a local rise in the temperature of the wavelength conversion element caused by concentrating the fundamental wave.

An image display according to another aspect of the present invention includes: the wavelength converting laser according to any of the above; and a modulation element modulating the converted wave emitted from the wavelength converting laser.

In this image display, the fundamental wave passes a plurality of times inside of the wavelength conversion element and forms a plurality of light-concentration points at places different from a cross point of the fundamental wave, thereby making it possible to obtain a high conversion efficiency stably and reduce the light-source area of a converted wave emitted as a plurality of beams, resulting in the whole apparatus being smaller.

The wavelength converting laser and the image display according to the present invention are capable of obtaining a high conversion efficiency stably and being miniaturized and are useful as a wavelength converting laser capable of converting the wavelength of a fundamental wave and outputting a converted wave having a different wavelength from the fundamental wave and an image display including the wavelength converting laser.

Herein, the specific implementation or embodiments given in the section of Detailed Description of the Preferred Embodiments of the Invention merely clarify the contents of an art according to the present invention, and hence, without being limited only to the specific examples and interpreted in a narrow sense, numerous variations can be implemented within the scope of the spirit of the present invention and the following claims.

What is claimed is:

1. A wavelength converting laser, comprising:
a light source emitting a fundamental wave; and
a wavelength conversion element converting the fundamental wave emitted from the light source into a converted wave having a different wavelength from the fundamental wave, wherein:
a pair of fundamental-wave reflecting surfaces is arranged on both end sides of the wavelength conversion element in the directions of an optical axis thereof and reflects the fundamental wave to thereby pass the fundamental wave a plurality of times inside of the wavelength conversion element, and at least one of the fundamental-wave reflecting surfaces transmits the converted wave; and
the pair of fundamental-wave reflecting surfaces allows the fundamental wave to cross inside of the wavelength conversion element and form a plurality of light-concentration points at places different from a cross point of the fundamental wave.

2. The wavelength converting laser according to claim 1, wherein the side faces of the wavelength conversion element reflect the fundamental wave into the wavelength conversion element.

3. The wavelength converting laser according to claim 2, further comprising a reflection portion made of a material having a refractive index lower than the wavelength conversion element and coating the side faces of the wavelength conversion element.

4. The wavelength converting laser according to claim 3, further comprising a temperature regulator regulating the temperature of the wavelength conversion element via the reflection portion.

5. The wavelength converting laser according to claim 2, wherein:
the wavelength conversion element has a rectangular shape in a section crossing the optical axis thereof; and
the direction of a polarization of the fundamental wave is parallel to a side of the section.

6. The wavelength converting laser according to claim 1, wherein:
the pair of fundamental-wave reflecting surfaces is formed in both end faces of the wavelength conversion element, respectively, in the optical-axis directions thereof; and
at least one of both end faces of the wavelength conversion element has a convex shape.

7. The wavelength converting laser according to claim 6, wherein at least one of both end faces of the wavelength conversion element has a convex cylindrical shape.

8. The wavelength converting laser according to claim 1, wherein one of the pair of fundamental-wave reflecting surfaces includes a cylindrical surface and the other includes a spherical surface.

9. The wavelength converting laser according to claim 1, wherein:
the pair of fundamental-wave reflecting surfaces is formed in both end faces of the wavelength conversion element, respectively, in the optical-axis directions thereof; and
one end face reflecting the fundamental wave and transmitting the converted wave of both end faces of the wavelength conversion element has an area smaller than the other end face.

10. The wavelength converting laser according to claim 1, wherein the wavelength conversion element has a thickness and a width of 1 mm or below.

11. The wavelength converting laser according to claim 3, wherein:
the wavelength conversion element is a flat plate having a predetermined thickness; and
the reflection portion is formed in two largest-area faces facing each other of the wavelength conversion element shaped like the flat plate.

12. The wavelength converting laser according to claim 1, wherein:
the pair of fundamental-wave reflecting surfaces is formed in both end faces of the wavelength conversion element, respectively, in the optical-axis directions thereof; and
one end face of both end faces of the wavelength conversion element reflects the fundamental wave and transmits the converted wave, and is connected to a multi-mode optical fiber propagating the converted wave.

13. The wavelength converting laser according to claim 12, wherein the connection end face of the multi-mode optical fiber to the wavelength conversion element reflects the fundamental wave and transmits the converted wave.

14. The wavelength converting laser according to claim 1, wherein the fundamental-wave reflecting surface transmitting the converted wave includes a transmission region for transmitting the converted wave and a reflection region for reflecting both the fundamental wave and the converted wave.

15. The wavelength converting laser according to claim 1, further comprising a vibration mechanism vibrating the wavelength conversion element when the converted wave is emitted.

16. The wavelength converting laser according to claim 1, wherein an image of an end face transmitting the converted wave of both end faces of the wavelength conversion element is projected on a modulation element modulating the converted wave.

17. The wavelength converting laser according to claim 1, wherein:
at least one of the pair of fundamental-wave reflecting surfaces includes a reflective film for reflecting the fundamental wave and the converted wave;
the plurality of light-concentration points are formed near the reflective film; and
the reflective film includes a metal film having a thickness of 100 nm or above.

18. An image display, comprising:
the wavelength converting laser according to claim 1; and
a modulation element modulating the converted wave emitted from the wavelength converting laser.
